(19) United States
(12) Patent Application Publication
(10) Pub. No.: US 2014/0019283 A1
(43) Pub. Date: Jan. 16, 2014

(54) MULTI-BENEFACTOR ITEM PAYMENT SYSTEM

(71) Applicant: Sean-Michael Daley, Irving, TX (US)

(72) Inventor: Sean-Michael Daley, Irving, TX (US)

(73) Assignee: RUMBLELOGIC, INC. DBD PAYTAP, Carrollton, TX (US)

(21) Appl. No.: 13/595,963

(22) Filed: Aug. 27, 2012

Related U.S. Application Data
(63) Continuation-in-part of application No. 13/550,417, filed on Jul. 16, 2012.

(51) Int. Cl. G06Q 30/06

(52) U.S. Cl. 705/26.2; 705/26.41

(57) ABSTRACT

A computer system includes one or more network interfaces configured to, for each of a plurality of benefactors, send to an electronic device of the benefactor information specifying an item desired by a beneficiary, wherein the item is offered for sale by a merchant at a price. The interfaces are also configured to, for each of the plurality of benefactors, receive from the benefactor electronic device information specifying a portion of the item price the benefactor agrees to pay. The computer system also includes a central processing unit (CPU) configured to determine that a sum of the portions of the item price the plurality of benefactors agreed to pay has reached the item price and in response pay the merchant for the item.

### CROSS REFERENCE TO RELATED APPLICATION(S)

This application is a continuation-in-part of co-pending U.S. patent application Ser. No. 13/550,417, filed Jul. 16, 2012, which is hereby incorporated by reference in its entirety for all purposes.

### BACKGROUND OF THE INVENTION

Everyday, across this and every other country, families and friends help one another out by giving or loaning money to pay essential bills. The payment may be one-off emergencies or longer-term arrangements that must be addressed month after month, year after year. This process can be difficult for both participants in the transaction. Often there are emotional issues, embarrassment, shame, pride that get in the way of asking for help. In other contexts, for example parents helping college students or children helping elderly parents, the difficulties are mostly logistics and complexity. In addition, vendors of goods and services are facing rising default rates and need to maximize their returns while retaining customers, particularly through difficult financial times, rather than alienating them by discontinuing their goods or services. Finally, there are philanthropic individuals and organizations that want to help needy people and need a way to find them that enables them to know the funds they provide are really going toward essential needs. What is needed is a system to address these and related problems.

### BRIEF SUMMARY OF INVENTION

In one aspect the present invention provides a computer system. The computer system includes one or more network interfaces configured to, for each of a plurality of benefactors, send to an electronic device of the benefactor information specifying an item desired by a beneficiary, wherein the item is offered for sale by a merchant at a price. The one or more network interfaces are also configured to, for each of the plurality of benefactors, receive from the benefactor electronic device information specifying a portion of the item price the benefactor agrees to pay. The computer system also includes a central processing unit (CPU) configured to determine that a sum of the portions of the item price the plurality of benefactors agreed to pay has reached the item price and in response pay the merchant for the item.

In another aspect the present invention provides a method. The method includes, for each of a plurality of benefactors, sending to an electronic device of the benefactor, by a computer system, information specifying an item desired by a beneficiary, wherein the item is offered for sale by a merchant at a price. The method also includes, for each of the plurality of benefactors, receiving from the benefactor electronic device, by the computer system, information specifying a portion of the item price the benefactor agrees to pay. The method also includes determining, by the computer system, in response to said receiving, that a sum of the portions of the item price the plurality of benefactors agreed to pay has reached the item price. The method also includes paying the merchant for the item, by the computer system, in response to said determining.

In yet another aspect the present invention provides a non-transitory computer-readable memory medium comprising program instructions, wherein the program instructions are executable by a processor to implement the following: for each of a plurality of benefactors, sending to an electronic device of the benefactor, by a computer system, information specifying an item desired by a beneficiary, wherein the item is offered for sale by a merchant at a price; for each of the plurality of benefactors, receiving from the benefactor electronic device, by the computer system, information specifying a portion of the item price the benefactor agrees to pay; determining, by the computer system, in response to said receiving, that a sum of the portions of item price the plurality of benefactors agreed to pay has reached the item price; and paying the merchant for the item, by the computer system, in response to said determining.

In yet another aspect the present invention provides an apparatus. The apparatus includes at least one computer. The apparatus also includes software that executes on the computer configured to, for each of a plurality of benefactors, send to an electronic device of the benefactor information specifying an item desired by a beneficiary, wherein the item is offered for sale by a merchant at a price. The apparatus also includes software that executes on the computer configured to, for each of the plurality of benefactors, receive from the benefactor electronic device information specifying a portion of the item price the benefactor agrees to pay. The apparatus also includes software that executes on the computer configured to determine that a sum of the portions of the item price the plurality of benefactors agreed to pay has reached the item price. The apparatus also includes software that executes on the computer configured to pay the merchant for the item when the sum of the portions of the item price the plurality of benefactors agreed to pay has reached the item price.

In yet another aspect the present invention provides a method. The method includes, for each of a plurality of benefactors, sending to an electronic device of the benefactor, by a computer system, information specifying an item desired by a beneficiary, wherein the item is offered for sale by a merchant at a price. The method also includes, for each of the plurality of benefactors, receiving, by the computer system, from the benefactor electronic device information specifying a portion of the item price the benefactor agrees to pay. The method also includes, for each of the plurality of benefactors, effecting, by the computer system, in response to said receiving, an electronic transfer of funds of the portion agreed to by the benefactor from a financial account of the benefactor to a financial account of the merchant.

In yet another aspect the present invention provides a method. The method includes receiving contact information of a benefactor, by a computer system, from an electronic device of a beneficiary. The method also includes sending an electronic communication, by the computer system, based on the contact information to an electronic device of the benefactor indicating the beneficiary's desire for an item offered for sale by a merchant. The method also includes receiving from the benefactor electronic device, by the computer system, payment instrument information. The method also includes paying the merchant for the item, by the computer system, using the payment instrument information. The computer system is operated by a third party, and the beneficiary, the benefactor, the merchant and the third party are all distinct entities.

### BRIEF DESCRIPTION OF THE DRAWINGS

FIG. 1 is a block diagram illustrating a financial network that includes a trusted third party payment (TTPP) system according to an embodiment of the present invention.

FIG. 2 is a flowchart illustrating operation of the TTPP system of FIG. 1 to enable bill helpers to pay the bills of bill owners according to the present invention.

FIG. 3 is a flowchart illustrating in more detail the operation at block 214 of FIG. 2 according to one embodiment of the present invention.

FIG. 4 is a flowchart illustrating in more detail the operation at blocks 226 and 228 of FIG. 2 according to one embodiment of the present invention.

FIG. 5 is a flowchart illustrating operation of the TTPP system of FIG. 1 to facilitate payment to billers of bill owner bills by bill helpers according to an alternate embodiment of the present invention.

FIGS. 6 through 20 are screen shots of various aspects of the user interface provided by the TTPP system of FIG. 1 to bill owners and bill helpers.

FIG. 21 is a block diagram illustrating a financial network that includes a trusted third party payment (TTPP) system according to an embodiment of the present invention.

FIG. 22 is a flowchart illustrating operation of the TTPP system of FIG. 21 to enable benefactors to pay for items desired by beneficiaries according to the present invention.

FIG. 23 is a flowchart illustrating in more detail the operation at block 2214 of FIG. 22 according to one embodiment of the present invention.

FIG. 24 is a flowchart illustrating in more detail the operation at blocks 2226 and 2228 of FIG. 22 according to one embodiment of the present invention.

FIG. 25 is a flowchart illustrating operation of the TTPP system of FIG. 21 to facilitate payment to merchants for items desired by beneficiaries by benefactors according to an alternate embodiment of the present invention.

FIG. 28 is a flowchart illustrating operation of the TTPP system of FIG. 21 to enable benefactors to pay for items desired by beneficiaries according to an alternate embodiment of the present invention.

FIG. 29 is a flowchart illustrating operation of the TTPP system of FIG. 21 to facilitate payment to merchants for items desired by beneficiaries by benefactors according to an alternate embodiment of the present invention.

FIG. 30 is a block diagram illustrating in more detail the TTPP system of FIGS. 1 and 21 according to an embodiment of the present invention.

FIGS. 31 through 35 are screen shots of various aspects of the user interface provided by the TTPP system of FIG. 21 to beneficiaries and benefactors.

### DETAILED DESCRIPTION OF THE EMBODIMENTS

### Glossary

Biller—A company, person or other legal entity that has issued a bill for payment of a good or service provided. Examples of billers may include, but are not limited to, utility companies, phone companies, mortgage companies, car loan companies, credit card companies, retail merchants, and the like.

Bill owner—A person or other legal entity to which a biller has issued a bill that has not been paid. That is, a bill owner is the entity that owes payment for the bill.

Bill helper—A person or organization or other legal entity that pays a bill owner's bill to a biller on behalf of the bill owner. The bill helper is distinct from the bill owner. Examples of bill helpers are family members and friends of the bill owner and philanthropic persons and organizations.

Item—A good or service offered for sale by a merchant.

Merchant—A company, person or other legal entity that offers items for sale.

Beneficiary—A person or other legal entity receives an item from a merchant that is paid for by one or more benefactors.

Benefactor—A person or organization or other legal entity that pays for an item for a beneficiary. The beneficiary is a distinct entity from the benefactor. Examples of benefactors are family members and friends of the beneficiary and philanthropic persons and organizations.

Financial Account—an account in a financial institution for holding money, which may include, but is not limited to, a bank account, debit card account, credit card account, or “electronic wallet” such as a PayPal account.

Trusted third party—a legal entity that develops and operates an electronic payment system that facilitates the payment of bill owner bills by bill helpers and/or the payment by benefactors for items to be received by beneficiaries. The trusted third party is licensed by each of the jurisdictions, where required, in which it transfers money to do so, either as a licensee by the jurisdiction or as a sub-licensee or agent. The trusted third party is a distinct legal entity from the bill owners/beneficiaries and bill helpers/benefactors; and, the bill owner, not the trusted third party, owes the bill to the biller; and, the beneficiary, not the trusted third party, receives the item from the merchant.

Memory Medium—Any of various types of memory devices or storage devices. The term “memory medium” is intended to include an installation medium, e.g., a CD-ROM, floppy disk, or tape device; a computer system memory or random access memory such as DRAM, DDR RAM, SRAM, EDO RAM, Rambus RAM, etc.; or a non-volatile memory such as a magnetic media, e.g., a hard drive, optical storage, FLASH memory, or solid-state disk (SSD). The memory medium may comprise other types of memory as well, or combinations thereof. In addition, the memory medium may be located in a first computer in which the programs are executed, and/or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, C#, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that a computer and/or software program may implement various embodiments described herein. A software program may be stored as program instructions on a memory medium.

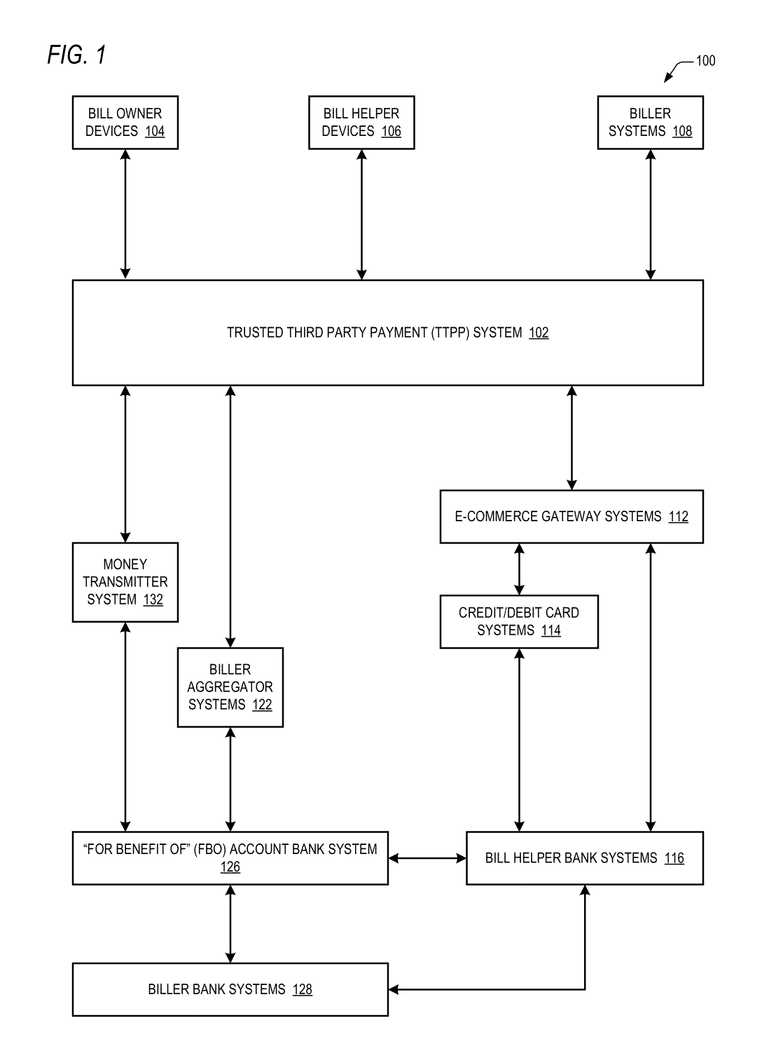

Referring now to FIG. 1, a block diagram illustrating a financial network 100 that includes a trusted third party payment (TTPP) system 102 according to an embodiment of the present invention is shown. The network 100 includes many computer systems and electronic devices in electronic communication with one another, that include: the TTPP system 102; bill owner devices 104; bill helper devices 106; one or more biller systems 108; an e-commerce gateway system 112; credit/debit card systems 114; bill helper bank systems 116; a biller aggregator system 122; a “for benefit of” (FBO) account bank system 126; biller bank systems 128; and a money transmitter system 132. Each of these systems is one or more computing devices capable of performing the functions described herein. For example, the systems may include, but are not limited to, a mainframe computer, mini-computer, super-computer, desktop computer, laptop computer, notebook computer, tablet computer, personal digital assistant, cell phone or other mobile device. Furthermore, each of the systems may be a combination of such computers in communication via a communications network, such as a local area network, wide area network, and/or telecommunications network. In one embodiment, the bill owner devices 104 and the bill helper devices 106 execute a web browser that accesses web pages provided by the payment system 102. Additionally, the biller systems 108 may execute a web browser that accesses web pages provided by the payment system 102.

The bill owner devices 104, bill helper devices 106, biller systems 108, e-commerce gateway systems 112, biller aggregator systems 122 and money transmitter system 132 are in communication with the TTPP system 102. The various bank systems—namely the credit/debit card systems 114, bill helper bank systems 116, FBO account bank system 126 and biller bank systems 128—are in communications with one another. The e-commerce gateway systems 112 are in communication with the credit/debit card systems 114 and the bill helper bank systems 116. The money transmitter system 132 and biller aggregator systems 122 are in communication with the TTPP system 102 and FBO account bank system 126. These various systems communicate via communications networks, such as local area networks, wide area networks, and/or telecommunications networks, such as the Internet, cell phone networks, or private telecommunications networks.

The bill owners operate the bill owner devices 104 to provide to the TTPP system 102 information about billers, bills and potential bill helpers that may be willing to help pay the bills. The bill helpers operate the bill helper devices 106 to obtain from the TTPP system 102 information about the bills of a bill owner and to provide to the TTPP system 102 payment instrument information with which the bill helper will pay the bill owner bills and to indicate which bills and what amount of each bill the bill helper is willing to pay. The billers operate the biller systems 108 in order to receive bill payments serviced by the TTPP system 102. Additionally, the biller systems 108 may provide to the TTPP system 102 bill owner bill information and track the progress of bill payments via a dashboard provided by the TTPP system 102, e.g., to see how many requests have been sent out to potential bill helpers for each bill owed to the biller and to track payments made.

E-commerce gateway providers—also referred to as payment gateway providers or merchant service providers or other similar terms—operate the e-commerce gateway systems 112 to provide processing of credit card, debit card, and automatic clearing house (ACH) payments. The e-commerce gateway providers authorize payments and protect payment instrument information, such as credit/debit card or bank account information, by encrypting the information as it is passed between the TTPP system 102 and the payment processor. Examples of e-commerce gateway providers are Online Resources Corp. (ORCC), Credit Management Systems (CMS), Authorize.net, CyberSource, Chase Paymentech, Elavon, First Data Corporation and Global Payments, Inc. The credit/debit card systems 114 are systems operated by VISA®, MasterCard®, Novus®, and Centurion®, among others. Although FIG. 1 shows a single block as the e-commerce gateway systems 112 and a single block as the credit/debit card systems 114, it should be understood that multiple transaction processors might be involved in the transactions that flow between the TTPP system 102 and the bill helper bank system 116.

A biller aggregator operates the biller aggregator systems 122 to facilitate payments from the FBO account bank system 126 to the biller bank systems 128. The biller aggregator has relationships with multiple billers who have authorized the biller aggregator to receive payments on behalf of the billers. Examples of biller aggregators are Online Resources Corp. (ORCC), FiServ, Inc. and MasterCard RPPS. It should be understood that the network 100 might also include the larger banking system of a particular country, such as the Federal Reserve Bank system in the United States of America, and/or the international banking system.

The FBO (“For the Benefit Of”) account is a holding account in which funds are received from bill helper accounts at the bill helper bank systems 116 and from which funds are transmitted to biller accounts at biller bank systems 128. The trusted third party operates the TTPP system 102 to cause these transfers of funds into and out of the FBO account. The trusted third party is a money transmitter licensed by each of the jurisdictions, where required, from which it transfers money into the FBO account or to which it transfers money from the FBO account and/or is a sub-licensee or agent of a money transmitter having a money transfer license or money transmission license or money-transferring license (different jurisdictions have different terminology and requirements) from each of the jurisdictions and which operates the money transmitter system 132. The TTPP system 102 provides to the money transmitter system 132 a report that includes the information of all payments into the FBO account system 126. The money transmitter system 132 also receives a report from the FBO account system 126 of payments into and out of the FBO account. This enables the money transmitter to audit the transfers made by the TTPP system 102 into the FBO account, for example to detect money laundering or fraudulent transactions. Examples of money transmitters are PreCash Inc., ADP Payroll Services Inc., Amazon Payments Inc., Facebook Payments Inc., MoneyGram Payment Systems Inc., PayPal Inc. Western Union Financial Services Inc. and Xoom Corporation. As mentioned above, in an alternate embodiment the trusted third party is a licensed money transmitter, and the trusted third party, rather than a sub-licensor or principal money transmitter, holds the FBO account. In one embodiment, a first FBO account is maintained for money transfers in which the trusted third party is licensed as a money transmitter in all relevant jurisdictions, and a second FBO account is maintained for money transfers involving jurisdictions in which the trusted third party is a sub-licensee or agent of another money transmitter. The trusted third party is a distinct legal entity from the bill owners and bill helpers; and, the bill owner, not the trusted third party, owes the bill to the biller. In one embodiment, the trusted third party that developed and will soon operate the TTPP system 102 is Rumblelogic, Inc DBA PayTap, Inc. of Carrollton, Tex.

The TTPP system 102 includes hardware computer systems and software programs executed by the hardware systems to perform the functions described herein. The TTPP system 102 includes storage devices capable of storing data processed by the software programs and of storing the software programs themselves. Additionally, the trusted third party may provide mobile applications to operate on the bill owner devices 104, bill helper devices 106 and/or the biller systems 108.

The following use cases are envisioned for the TTPP system 102 described herein, although the uses are not limited to those listed.

An individual needing help paying his bills may create an account on the TTPP system 102, enter bill information and potential bill helper contact information and have the bills paid by bill helpers via the TTPP system 102.

Companies (billers) that have customers behind in their payments do not want to refer their customers to a collection agency because they will likely lose the account if they do so, and if they do get payment it will likely be pennies on the dollar, may be motivated to encourage their customers (bill owners) to use the TTPP system 102. For example, the company website may promote the TTPP system 102 and customer service representatives of company may direct customers who are behind on their payments to the TTPP system 102 to get help paying their bills from friends and family or other bill helpers. Furthermore, as mentioned above, the company may be willing to pay the trusted third party a fee for the services provided by the TTPP system 102.

Parents and grandparents of college students may use the TTPP system 102 to identify critical and discretionary expenses and receive reminders from the TTPP system 102 to ensure payments are made in time.

Grown children of elderly parents may avoid the logistical difficulties of coordinating the payments of multiple siblings for different bills, partial payments, and varying payment schedules by using the TTPP system 102. Additionally, the adult children may enjoy the logistical benefits and simplicity of the TTPP system 102 to pay their parents' bills from the convenience of their bill helper devices 106 for their parents who have medical conditions that render them physically unable to pay their bills.

Community and charity groups organizing contributions to needy individuals and/or families may list their bills on the TTPP system 102 and thereby enable their community of givers to easily select a bill owner to help and to quickly and easily pay a bill and audit the payment of the bill owner's bills.

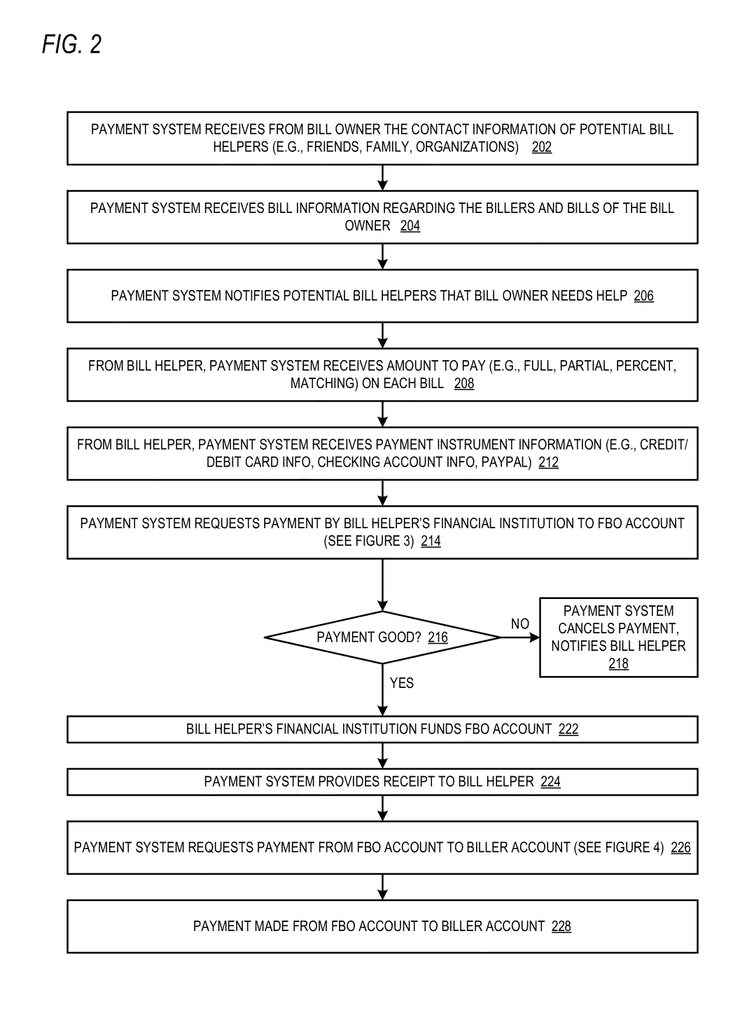

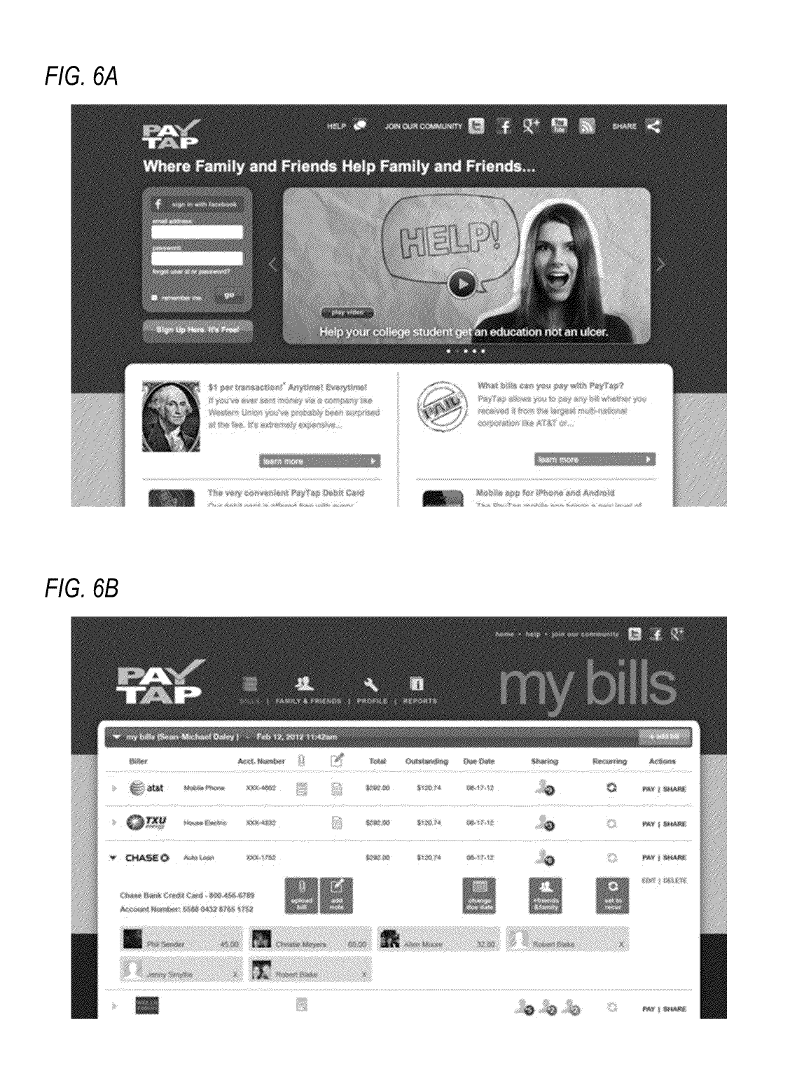

Referring now to FIG. 2, a flowchart illustrating operation of the TTPP system 102 of FIG. 1 to enable bill helpers to pay the bills of bill owners according to the present invention is shown. FIG. 6A is a screen shot illustrating a home page of a website provided for users of the TTPP system 102 according to one embodiment. As shown, the TTPP system 102 provides ways for the user to learn about the TTPP system 102, to sign up to create an account, and/or to login to the user's account on the TTPP system 102 by providing security credentials. As also shown, the TTPP system 102 provides the ability to sign in with the user's Facebook account or other social media account. FIG. 6B is a screen shot illustrating another web page provided by the TTPP system 102 for a user that lists the bill owner's bills once entered into the TTPP system 102, as described in more detail herein, and to update information about the bills, such as changing the due date of the bill, updating the bill helpers that are notified about the bills, toggling the recurring nature of the bill, adding a note about the bill and uploading an image of a new bill. Flow begins at block 202.

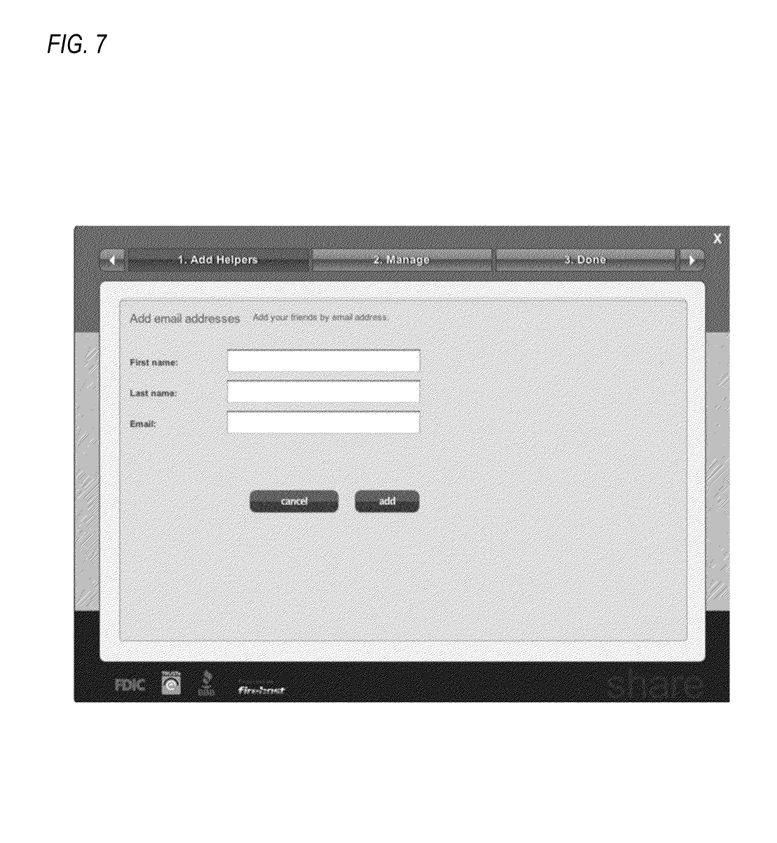

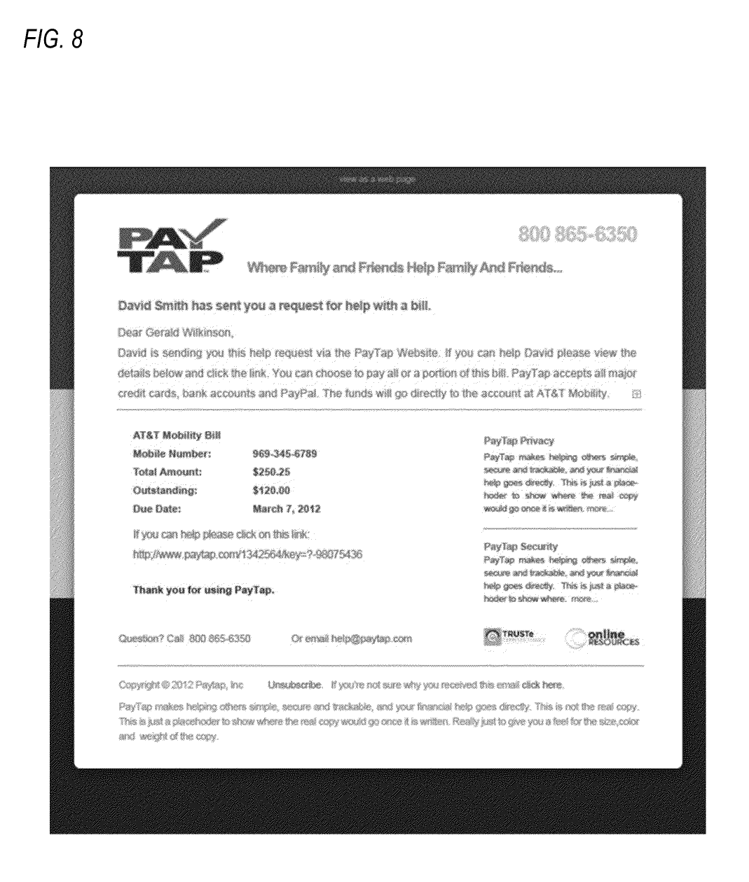

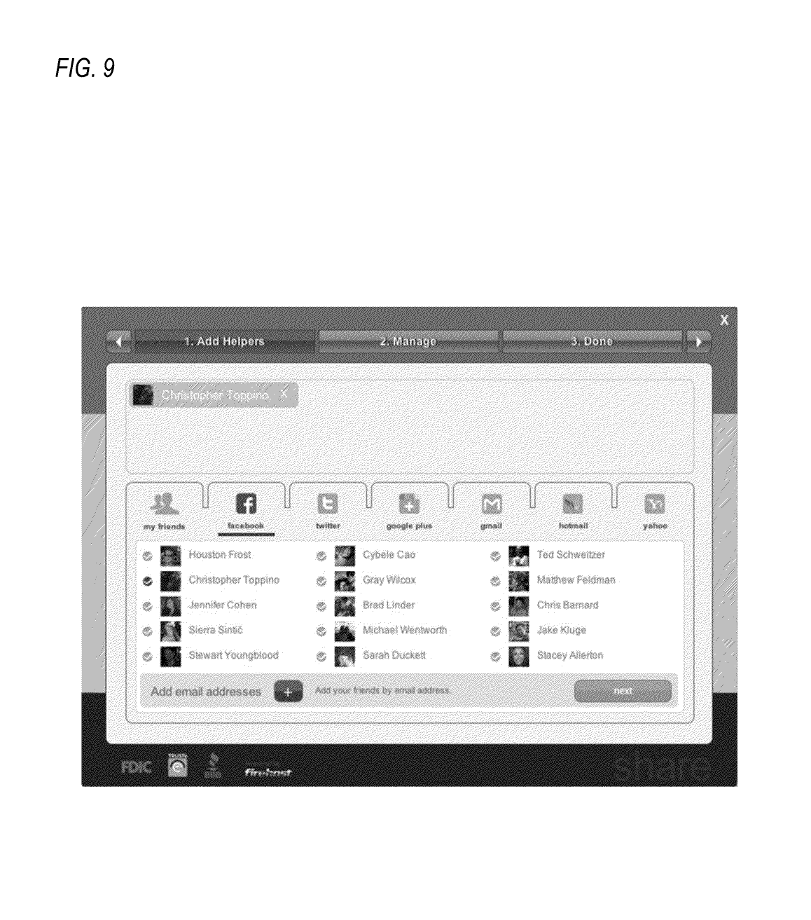

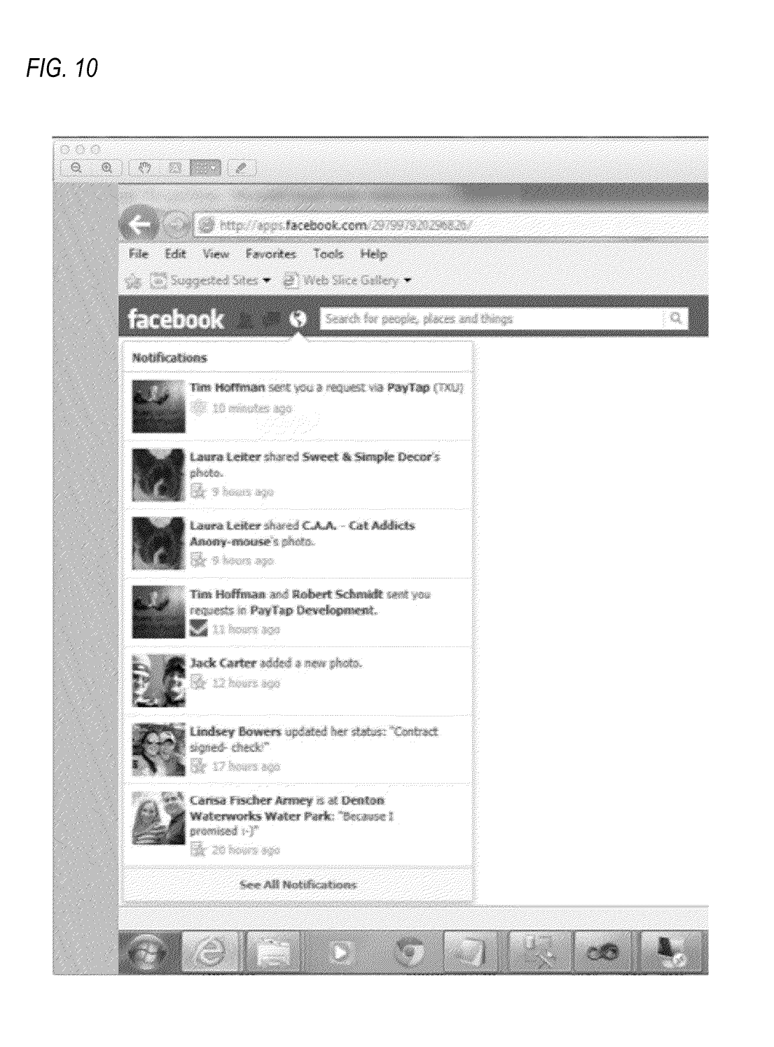

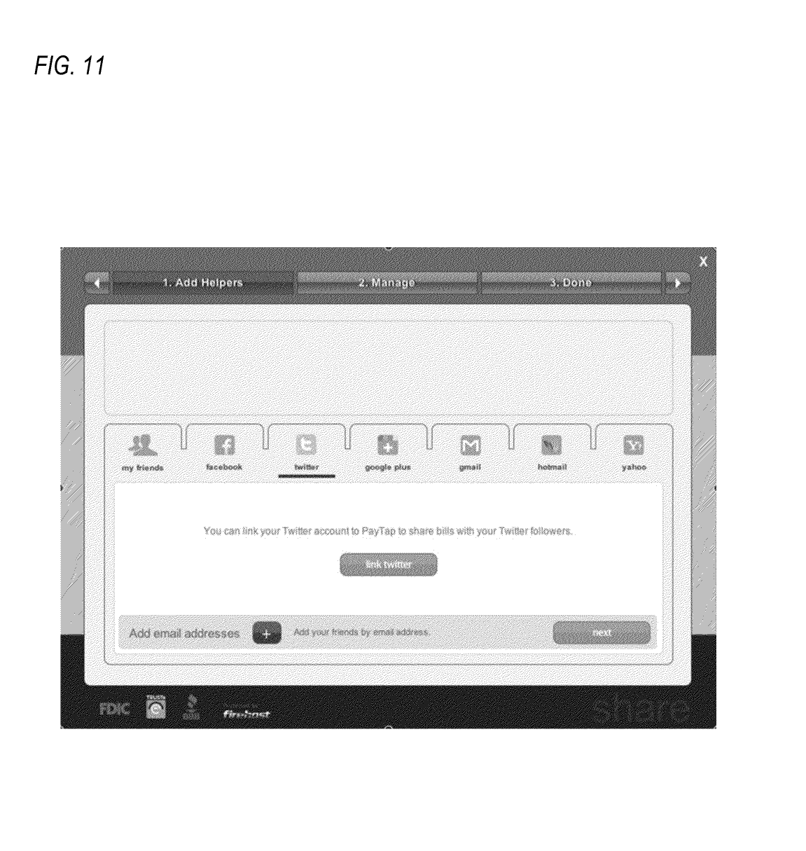

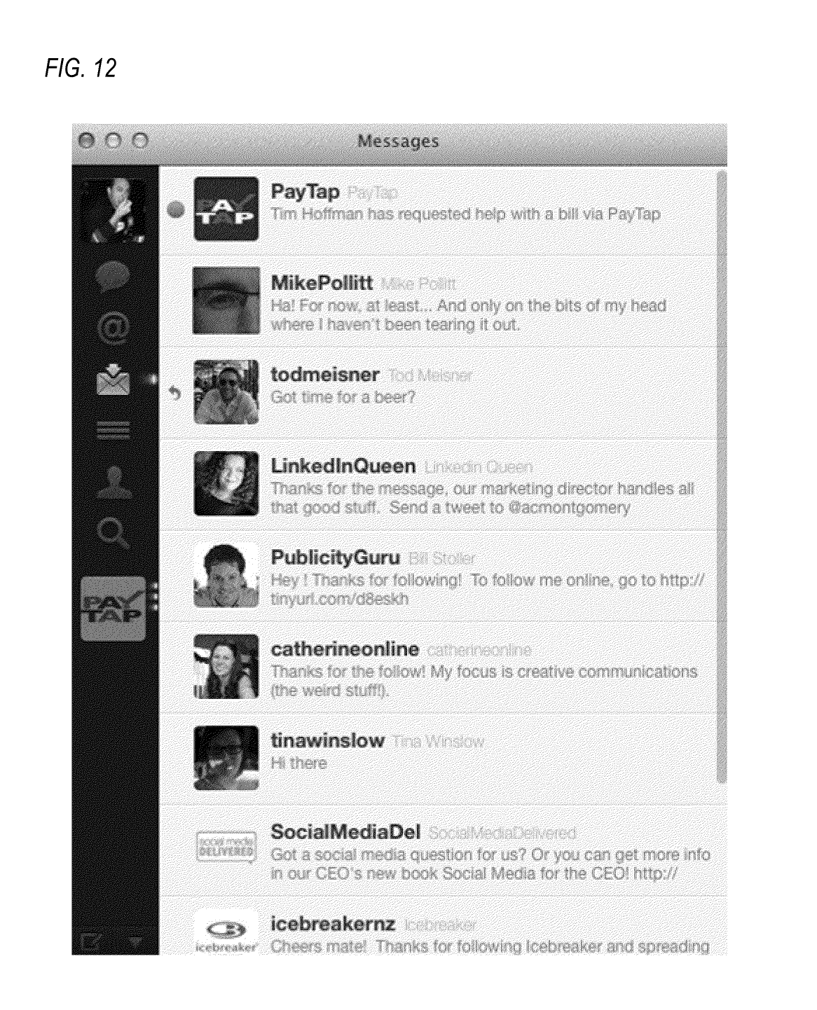

At block 202, the bill owner accesses the TTPP system 102 using a bill owner device 104. The TTPP system 102 receives information from each bill owner that enables the TTPP system 102 to contact potential bill helpers that the bill owner thinks may be willing to help the bill owner pay his bills. In one embodiment, the TTPP system 102 provides a user interface on the bill owner device 104 that enables the bill owner to enter the name and email address of potential bill helpers into the TTPP system 102, as shown in the screen shot of FIG. 7. Subsequently, the TTPP system 102 sends an email message to the potential bill helper's device 106 about the bill owner's bills. For example, the screen shot of FIG. 8 shows an email message sent to a potential bill helper regarding an AT&T Mobility bill that needs to be paid, including the bill owner's name, the mobile number, total amount of the bill, the outstanding amount due, the due date of the bill, and a link the potential bill helper can click on to go to the TTPP system 102 to pay the bill. In one embodiment, the bill owner may provide Facebook® account information to the TTPP system 102 to enable the TTPP system 102 to determine the bill owner's Facebook friends. The TTPP system 102 user interface then displays the Facebook friends for the bill owner, and the bill owner clicks on the Facebook friends to add to the list of potential bill helpers, as shown in the screen shot of FIG. 9. Subsequently, the TTPP system 102 sends a Facebook notification to the selected friends about the bills of the bill owner that need to be paid. For example, the screen shot of FIG. 10 shows a Facebook notification on the Facebook page of a potential bill helper regarding a utility bill to TXU Energy that needs to be paid. In one embodiment, as shown in the screen shot of FIG. 11, the user interface of the TTPP system 102 enables the bill owner to link his Twitter account to the TTPP system 102 to share bills with potential bill helpers who are Twitter followers of the bill owner. The TTPP system 102 subsequently sends a Twitter tweet, or message, as shown in the screen shot of FIG. 12, about the request for help with a bill via the TTPP system 102. In other embodiments, the TTPP system 102 may provide notifications to potential bill helpers about the bill owner's bills via other social media outlets. Furthermore, the bill owner may provide the cell phone number of potential bill helpers so that the TTPP system 102 may send text messages to them about the bill owner's bills. Alternatively, the TTPP system 102 may receive potential bill helper contact information from the bill helpers themselves. For example, a bill helper may be an individual or charitable organization that wants to help a bill owner whom the bill helper does not even know. Flow proceeds to block 204.

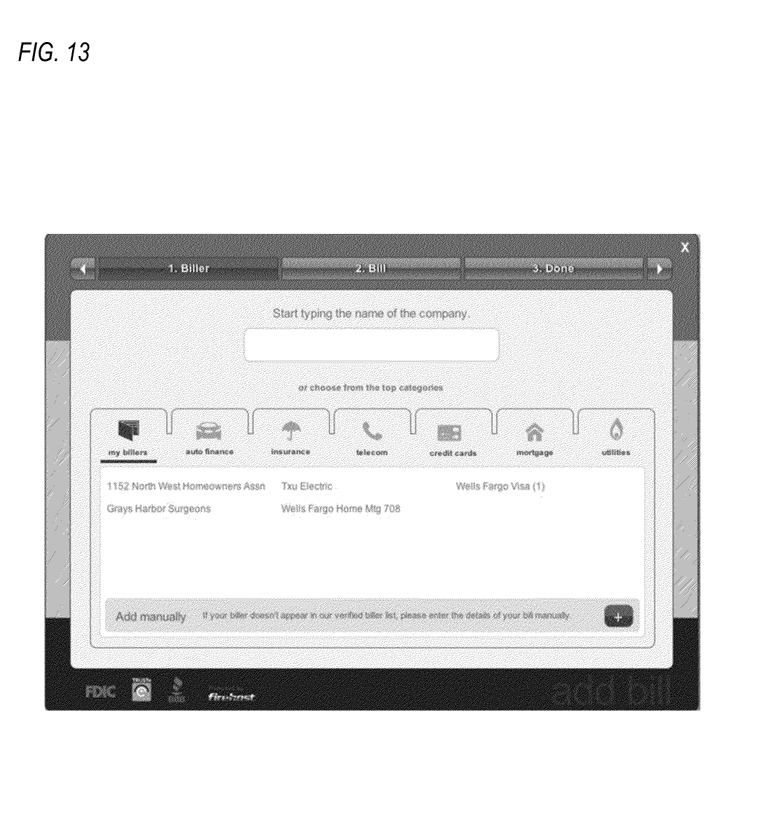

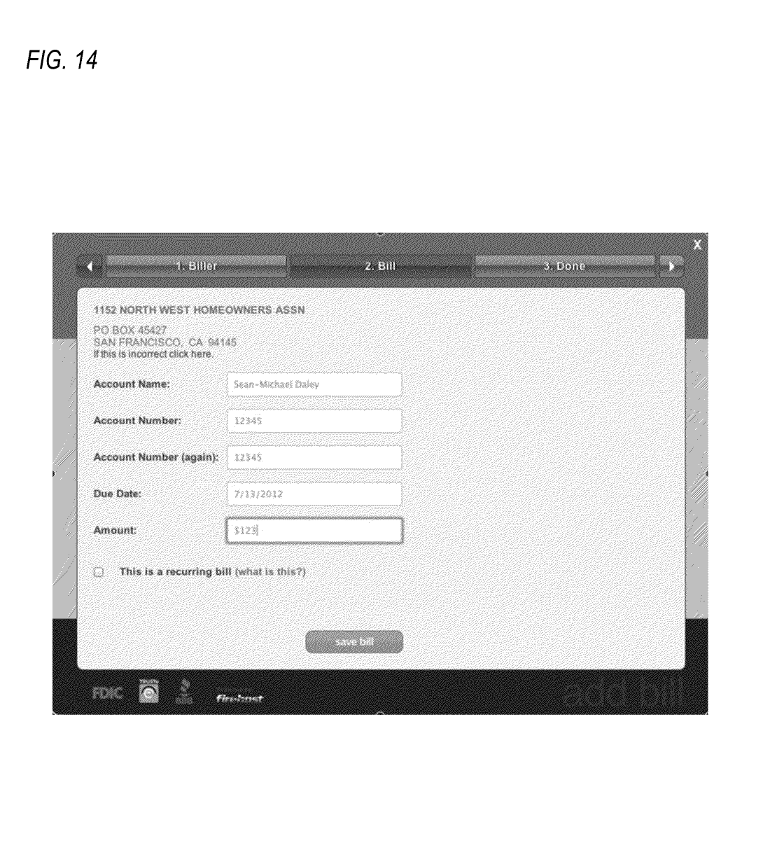

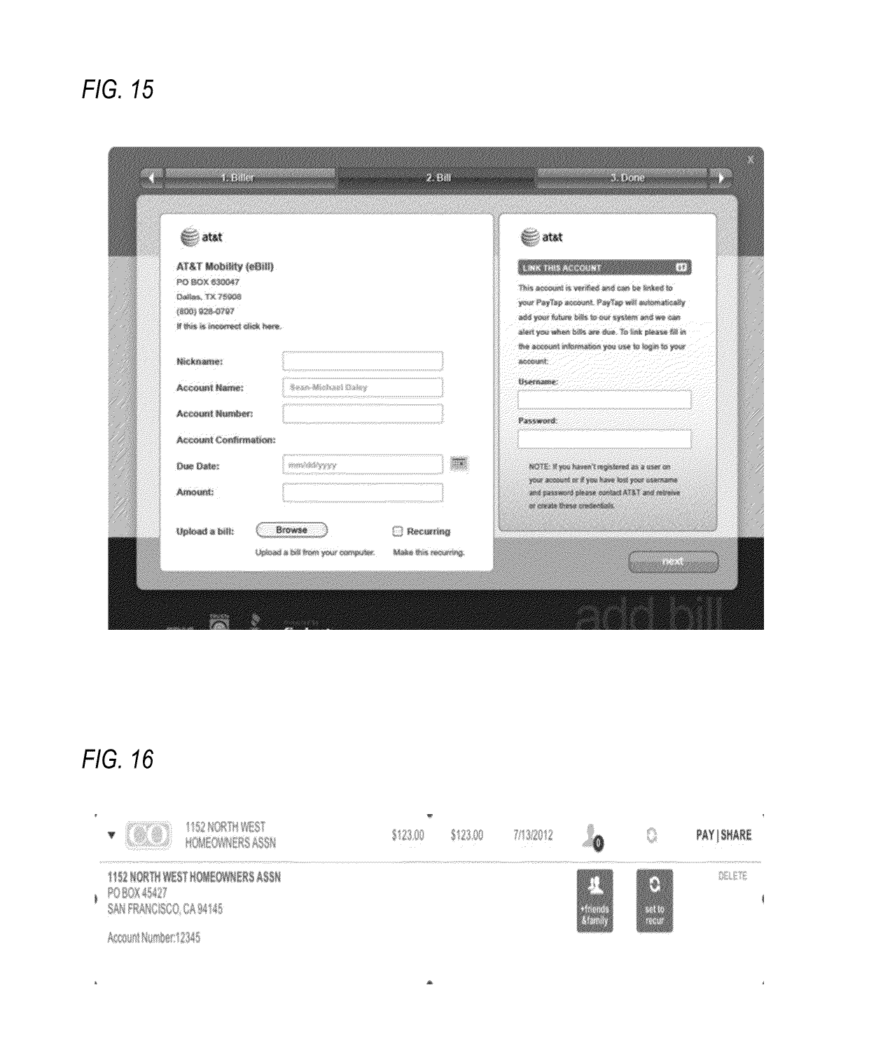

At block 204, the TTPP system 102 receives information regarding the billers and the bills of each bill owner. The TTPP system 102 provides a user interface to the bill owner device 104 that enables the bill owner to identify billers. The TTPP system 102 enables the bill owner to pick the biller from a list of billers known to the TTPP system 102. The pick list may include the list of billers with which the bill aggregator has relationships and has the biller financial account information needed to electronically transfer funds from the FBO account bank system 126 to the biller bank systems 128. These billers are referred to as verified billers because the bill aggregator has already verified the biller's legitimacy and bank account information. This approach advantageously reduces the likelihood of a fraudulent biller being able to receive payments from the TTPP system 102. Alternatively, the bill owner may manually enter the biller information. These billers are referred to as unverified billers. The trusted third party may subsequently verify the manually entered biller and then add the newly verified biller to the pick list of verified billers. FIG. 13 is a screen shot showing an example of the user interface provided to the bill owner for providing biller information. The biller information may include the biller name and address, as well as the bill owner account number, as shown in the screen shot of FIGS. 14-16. The trusted third party may also obtain the financial account information needed to electronically transfer funds from the FBO account to the biller bank system 128. Once the biller information is in the TTPP system 102, the bill owner provides to the TTPP system 102 information regarding a bill owed to the biller. The bill information may include the bill owner's name, account number, due date and amount due, as shown in the screen shot of FIGS. 14-16. In one embodiment, after a bill owner enters the bill information, the TTPP system 102 verifies the bill information with the biller, and if the bill is not valid, the TTPP system 102 does not allow bill helpers to pay the bill. In one embodiment, the bill owner may upload an image of the bill (e.g., a scanned image or photo) to the TTPP system 102 to enable the TTPP system 102 to display the image of the bill for potential bill helpers, as shown in FIG. 15. This enables the bill helpers to verify the validity of the bill. In one embodiment, the bill owner may authorize the TTPP system 102 to obtain the bill information directly from the biller systems 108. For example, the screen shot of FIG. 15 shows a user interface provided by the TTPP system 102 to the bill owner device 104 at which the bill owner may enter his AT&T Mobility account username and password in order to link the bill owner's account to the TTPP system 102 so that the TTPP system 102 can automatically add bills from the biller to the TTPP system 102 and alert the bill owner when the bills are due. Flow proceeds to block 206.

At block 206, TTPP system 102 sends a message to the potential bill helpers identified by the bill owner using the contact information received at block 202. The message indicates that the bill owner needs help paying bills. The TTPP system 102 may enable the bill owner at block 202 to create a customized message to be sent to the potential bill helpers or to pick a stock message created by the TTPP system 102, such as an email message, Facebook notification or Twitter tweet. The message may also include information that enables the bill helper to access the TTPP system 102 in order to view the bill information received at block 204. For example, the message may include a link on which the bill helper may click which will take the potential bill helper to a website of the TTPP system 102. FIGS. 8, 10 and 12 are screen shots that illustrate an example of an email message, Facebook notification and Twitter tweet, respectively, provided to the potential bill helper, as discussed above with respect to block 202. Flow proceeds to block 208.

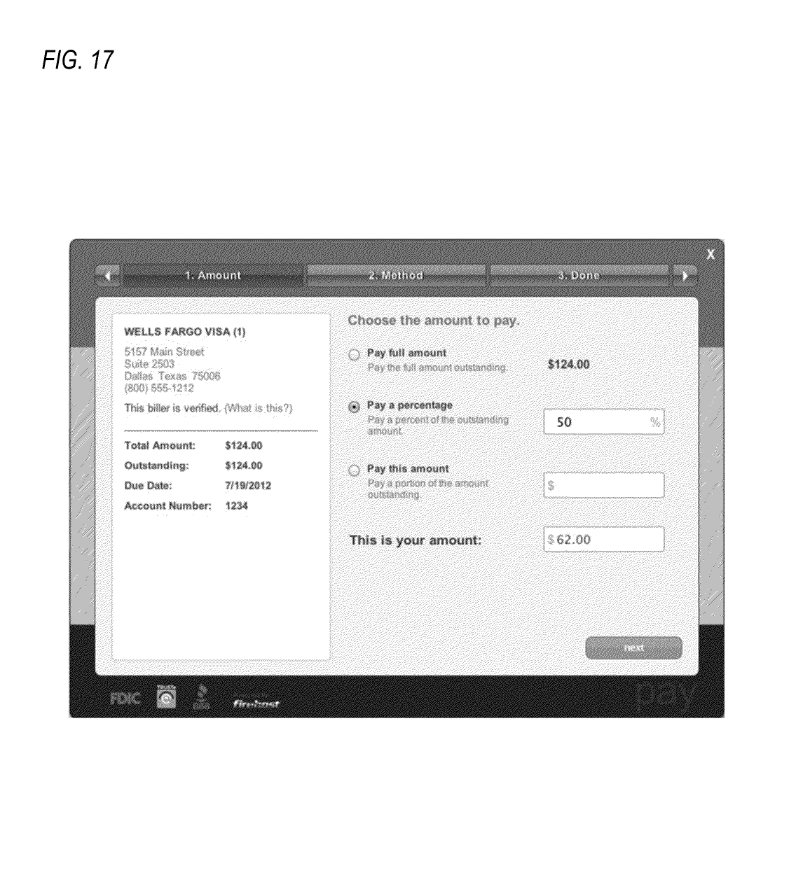

At block 208, bill helpers access the TTPP system 102 from bill helper devices 106 to pay bills for a bill owner. The TTPP system 102 receives from each bill helper for each bill the bill helper wants to pay the amount the bill helper wants to pay on the bill. Preferably, the bill helper can make a full payment or a partial payment of the bill, such as a percentage of the bill or a partial dollar amount, as shown in the screen shot of FIG. 17. In one embodiment, the TTPP system 102 enables the bill helper to specify a matching payment in which the bill helper pays an amount that matches the amount paid by other bill helpers and/or the bill owner himself. The matching payment may be contingent upon payment by the other payer or payers. In one embodiment, the TTPP system 102 enables the bill helper to specify that the bill payment should be recurrent. In one embodiment, as a bill helper makes a payment, the outstanding amount due on the bill that is shown to bill helpers is reduced by the amount paid, and the TTPP system 102 does not allow a bill helper to pay more than the outstanding amount. Advantageously, this reduces the likelihood of bill helpers overpaying the bill. Preferably, if the biller makes a refund back to the TTPP system 102, the TTPP system 102 subsequently makes the refund back to the bill helper rather than to the bill owner. Flow proceeds to block 212.

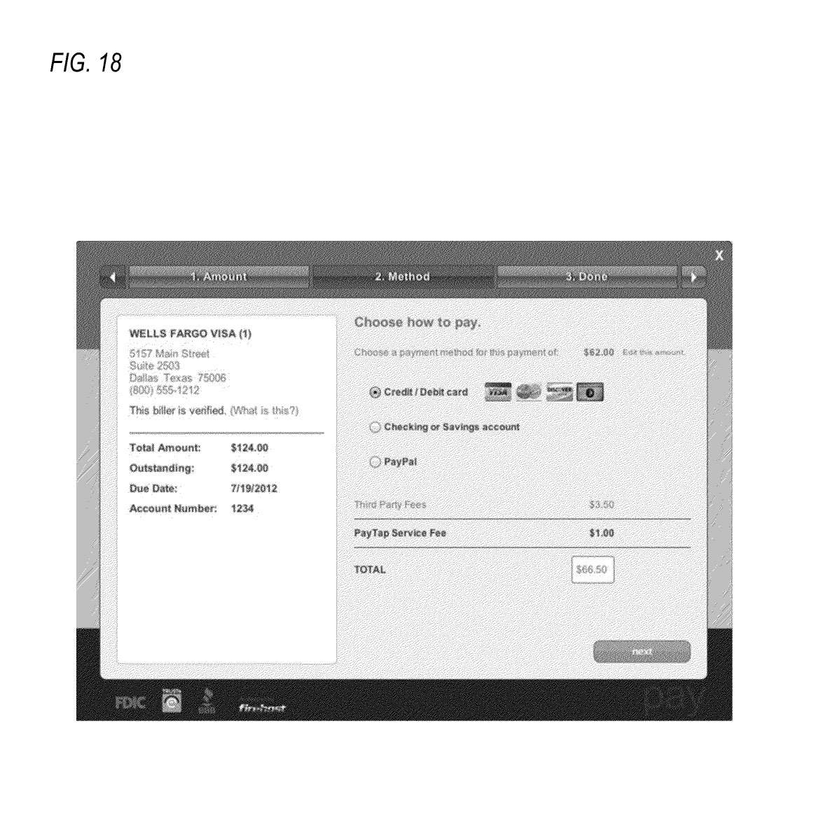

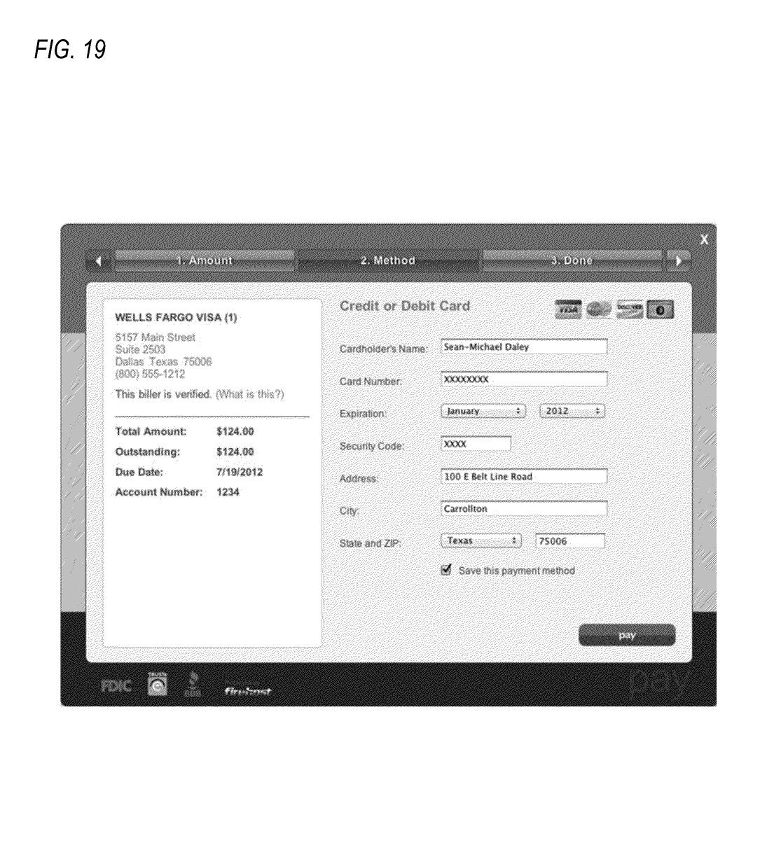

At block 212, the TTPP system 102 receives from the bill helper payment instrument information of the bill helper. Preferably, the bill helper first selects a payment method, or payment instrument, such as a credit or debit card, checking or savings account (commonly referred to as an automatic clearing house (ACH) payment), or other payment method such as PayPal® or other “electronic wallet” online payment system, as shown in the screen shot of FIG. 18. Once the bill helper selects a payment instrument, the TTPP system 102 calculates the fees that it will charge to the bill helper for the services provided and communicates fees to the bill helper, as shown in FIG. 18. The fees that may be charged include, but are not limited to, the following. The TTPP system 102 may charge a fee per bill payment for the services provided by the TTPP system 102, which may be a fixed amount per bill payment (e.g., one dollar, as shown in FIG. 18) or may be a percentage of the payment amount, for example. The TTPP system 102 may also pass on to the bill helper third party transaction fees (shown in FIG. 18 as $3.50) charged to the TTPP system 102 for paying the bill, such as transaction fees charged by the e-commerce gateway system 112, the credit/debit card company systems 114, and the biller aggregator systems 122. Because the third party transaction fees incurred by the TTPP system 102 may vary with the payment instrument type, the fees passed on to the bill helper by the TTPP system 102 may also vary accordingly. If the bill helper does not accept the fees, the payment is cancelled. Otherwise, the TTPP system 102 proceeds with the payment process. According to other embodiments, the TTPP system 102 charges at least a portion of the fees to the biller and/or bill owner, rather than or in addition to the bill helper. After selecting a payment instrument, the bill helper provides information about the payment instrument. In the case of a credit/debit card, the payment instrument information may include the name of the card holder (i.e., the bill helper), the card number, the expiration date, security code and mailing address, as shown in the screen shot of FIG. 19. In the case of an ACH payment, the payment instrument information may include the routing number of the bank 116 at which the account is held, the account number and the name of the account holder (i.e., the bill helper). In the case of a PayPal payment, preferably the TTPP system 102 directs the bill helper to the PayPal website where the bill helper makes a PayPal payment to the trusted third party's PayPal account. Flow proceeds to block 214.

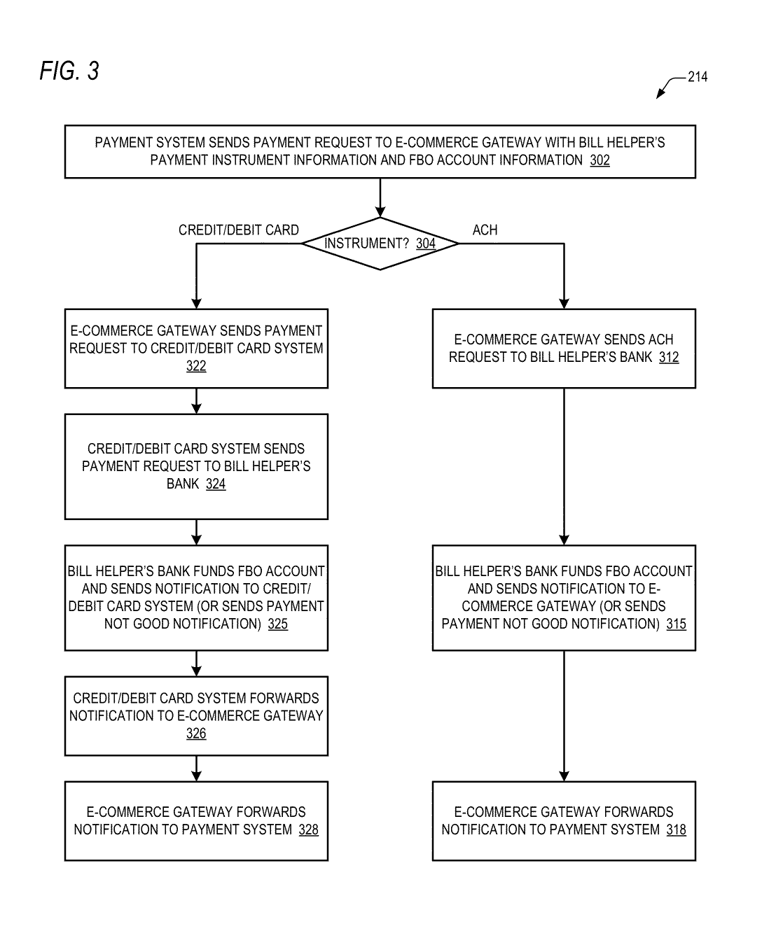

At block 214, the TTPP system 102 requests that payment be made by the bill helper's financial institution 116 to the FBO account at the FBO account bank system 126. Preferably, the payment request includes a payment amount that is equal to the sum of the amount the bill helper indicated it would pay on the bill of the bill owner at block 208 and the fee communicated at block 212. The operation of block 214 is described in more detail below with respect to FIG. 3. Flow proceeds to decision block 216.

At decision block 216, the TTPP system 102 determines the status of the payment requested at block 214. That is, the TTPP system 102 determines whether the bill helper's bank system 116 made the payment to the FBO account system 126. For example, the TTPP system 102 may receive a message from the e-commerce gateway system 112, as discussed with respect to FIG. 3, which indicates the payment request was made. On the other hand, the TTPP system 102 may receive a timeout from the e-commerce gateway system 112 or an indication that the bill helper's account has insufficient funds, was closed, or has exceeded its credit limit. If the TTPP system 102 determines that the payment was made, flow proceeds to block 222; otherwise, flow proceeds to block 218.

At block 218, the TTPP system 102 cancels the payment and notifies the bill helper that the payment was cancelled. Flow ends at block 218.

At block 222, the bill helper bank system 116 funds the FBO account 126. Flow proceeds to block 224.

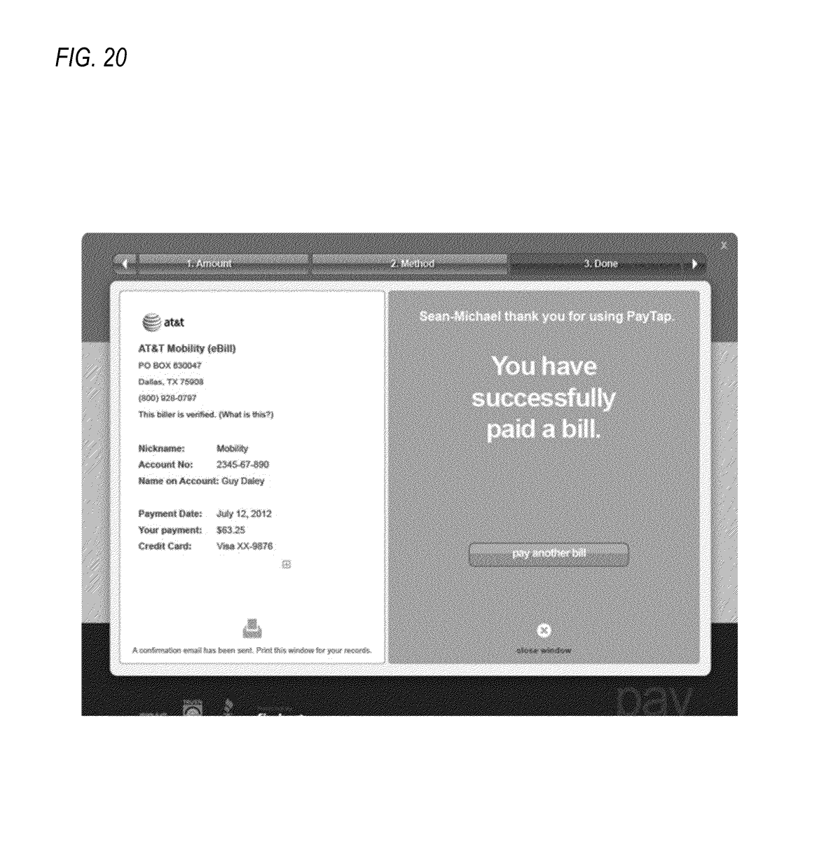

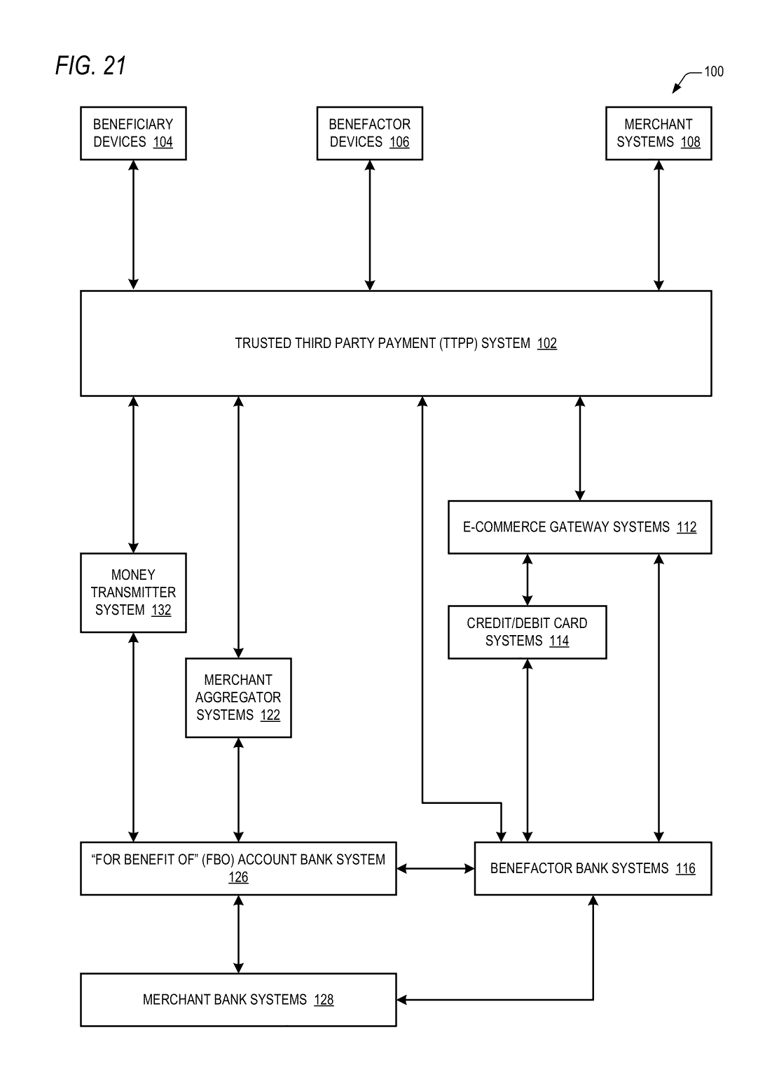

At block 224, the TTPP system 102 provides to the bill helper a receipt of the payment. FIG. 20 is a screen shot that shows an example of confirmation provided to the bill helper by the TTPP system 102. Flow proceeds to block 226.

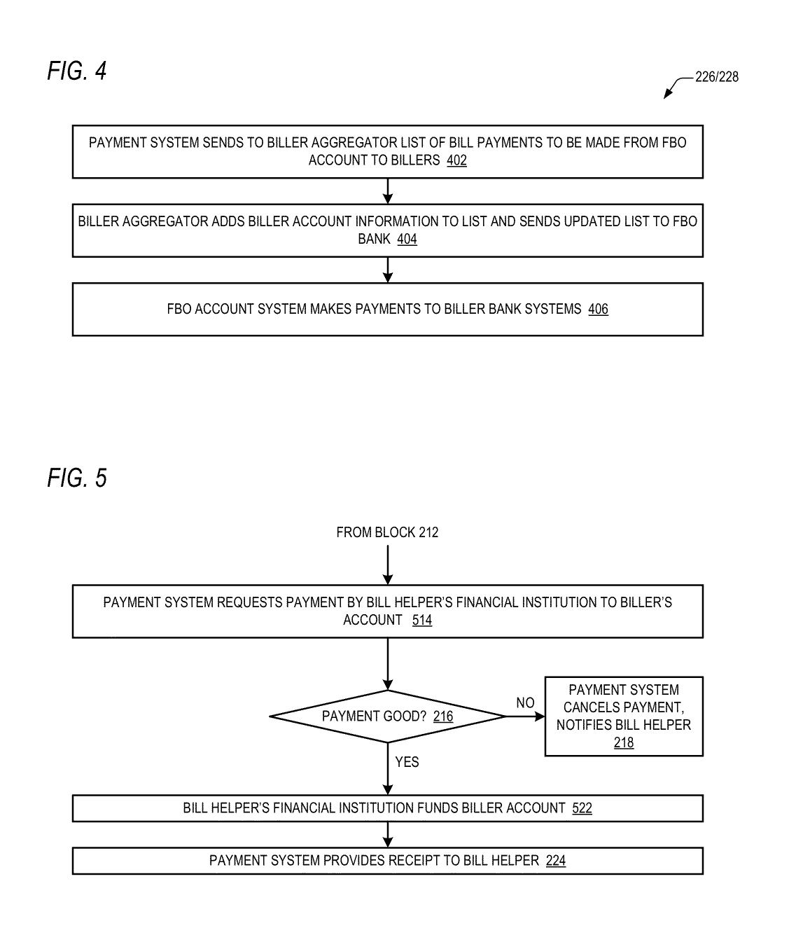

At block 226, the TTPP system 102 requests payment from the FBO account to the biller account at the biller bank system 128. In one embodiment, many payments are made at block 222 over the course of a day into the FBO account from many different bill helper financial accounts for many different bills of many different bill owners that accumulate in the FBO account. The accumulated payments may be of various types, as described above, e.g., credit/debit cards, ACH payments, PayPal payments. In one embodiment, in the case of an ACH payments, the TTPP system 102 may wait a few days after the bill helper authorizes payment on a bill to pay the biller bank system 128 in order to reduce the likelihood that the funds from the bill helper account bank system 116 are not available (e.g., the account was overdrawn or closed). Thus, if the bill helper chooses an ACH payment instrument at block 212 and the due date is within the number of days the TTPP system 102 waits to pay the bill, the TTPP system 102 gives the bill helper the opportunity to pay by another method. The operation of block 226 is described in more detail below with respect to FIG. 4. Flow proceeds to block 228.

At block 228, a payment is made from the FBO account to the biller account at the biller bank system 128. The operation of block 228 is also described below with respect to FIG. 4. Flow ends at block 228.

Although portions of FIG. 2 may describe the flow through the TTPP system 102 of a single payment of a single bill by a single bill helper of a single bill owner to a single biller, it should be understood that one or more bill owners may each post one or more bills owed to one or more billers to the TTPP system 102, and one or more bill helpers may pay one or more bills for one or more bill owners via the TTPP system 102. Furthermore, a bill helper may make a partial payment of a bill.

Referring now to FIG. 3, a flowchart illustrating in more detail the operation at block 214 of FIG. 2 according to one embodiment of the present invention is shown. Flow begins at block 302.

At block 302, the TTPP system 102 sends a payment request to the e-commerce gateway system 112 with the payment amount obtained at block 208 (including fees, as described herein), the bill helper payment instrument information obtained at block 212 and the FBO account information. If the bill helper elects to pay using an online payment service, such as PayPal, the TTPP system 102 redirects the bill helper's device 106 to the PayPal website where the bill helper makes a payment to the PayPal account of the trusted third party and receives a payment confirmation from the PayPal system. Subsequently, the TTPP transfers the payment amount (less fees) to the FBO account bank system 126. Flow proceeds to decision block 304.

At decision block 304, if the payment instrument is a credit/debit card, flow proceeds to block 322; otherwise, if an ACH transaction, e.g., checking or savings account, flow proceeds to block 312.

At block 312, in response to receiving the request sent at block 302, the e-commerce gateway system 112 sends to the bill helper bank system 116 an ACH request to transfer funds from the bill helper's checking or savings account to the FBO account. Flow proceeds to block 315.

At block 315, in response to receiving the request sent at block 312, the bill helper bank system 116 funds the FBO account from the bill helper's account and sends a notification to the e-commerce gateway system 112 that the payment was made, or sends a notification that the payment was not good (e.g., insufficient funds, credit limit exceeded). Flow proceeds to block 318.

At block 318, the e-commerce gateway system 112 forwards the notification sent by the bill helper bank system 116 at block 315 to the TTPP system 102. Flow ends at block 318.

At block 322, in response to receiving the request sent at block 302, the e-commerce gateway system 112 sends to the credit/debit card system 114 a request to transfer funds from the bill helper's credit/debit card account to the FBO account. Flow proceeds to block 324.

At block 324, in response to receiving the request sent at block 322, the credit/debit card system 114 sends to the bill helper bank system 116 (i.e., the bank that issued the credit/debit card to the bill helper) a request to transfer funds from the bill helper's credit/debit card account to the FBO account. Flow proceeds to block 325.

At block 325, in response to receiving the request sent at block 324, the bill helper bank system 116 funds the FBO account from the bill helper's credit/debit account and sends a notification to the credit/debit card system 114 that the payment was made, or sends a notification that the payment was not good. Flow proceeds to block 326.

At block 326, the credit/debit card system 114 forwards the notification sent by the bill helper bank system 116 at block 325 to the TTPP system 102. Flow proceeds to block 328.

At block 328, the e-commerce gateway system 112 forwards the notification forwarded by the credit/debit card system 114 at block 326 to the TTPP system 102. Flow ends at block 328.

Referring now to FIG. 4, a flowchart illustrating in more detail the operation at blocks 226 and 228 of FIG. 2 according to one embodiment of the present invention is shown. Flow begins at block 402.

At block 402, the TTPP system 102 sends to the biller aggregator system 122 a list of bill payments to be made from the FBO account to the various biller bank systems 128. As discussed herein, the biller may agree to pay the trusted third party a fee per bill payment for the benefits provided by the TTPP system 102, in which case the TTPP system 102 deducts the fee from the amount of the bill payment from the FBO account to the biller. Furthermore, as discussed herein, the biller may agree to pay to the trusted third party transaction processing fees, or a portion thereof, associated with a given bill payment, in which case the TTPP system 102 deducts the fee from the amount of the bill payment from the FBO account to the biller. Additionally, for billers who accept partial payments, the TTPP system 102 may cause partial payments of a given bill to be made from the FBO account to the biller. This may be particularly beneficial to the bill owner if the biller is charging the bill owner interest on a daily basis. Flow proceeds to block 404.

At block 404, the biller aggregator system 122, which has the account information for each biller, takes the list received from the TTPP system 102 at block 402 and adds the biller's account information to each bill payment. The biller aggregator system 122 then sends the updated list to the FBO account bank system 126. In one embodiment, the biller aggregator system 122 sends a file, referred to as a “FED-ready file,” that includes a list of single line entry ACH debit transactions to be made from the FBO account system 126 to the biller bank systems 128. The bill aggregator system 122 may consolidate payments to the same biller. In one embodiment, if the biller is one for which the TTPP system 102 does not have the information necessary to make an electronic funds transfer to the biller bank system 128, the biller aggregator system 122 generates a physical check and mails it to the biller at the address provided by the bill owner at block 204. Flow proceeds to block 406.

At block 406, the FBO account bank system 126 makes the bill payments specified in the list sent at block 404 to the biller bank systems 128. Flow ends at block 406.

Referring now to FIG. 5, a flowchart illustrating operation of the TTPP system 102 of FIG. 1 to facilitate payment to billers of bill owner bills by bill helpers according to an alternate embodiment of the present invention is shown. In the embodiment of FIG. 5, the biller has a relationship with the trusted third party such that the TTPP system 102 facilitates direct transfers from the bill helper bank system 116 to the biller bank system 128 rather than indirectly through the FBO account. FIG. 5 is similar to FIG. 2 and like-numbered blocks indicate like operations. For simplicity, blocks 202 through 212 are not shown; blocks 226 and 228 are not included; block 214 is replaced by block 514; and block 222 is replaced by block 522.

At block 514, the TTPP system 102 requests that payment be made by the bill helper's financial institution to the biller's account at the biller bank system 128. Processing of the request made at block 514 is similar to the processing described with respect to FIG. 3, except that the biller's account at the biller bank system 128 is the target of the payment rather than the FBO account. That is, the biller has provided its merchant ID to the TTPP system 102 and has authorized the TTPP system 102 to accept payments on its behalf. Flow proceeds to decision block 216.

At block 522, the bill helper bank system 116 funds the biller's account in the biller bank system 128. Flow proceeds to block 224.

It should be understood that the TTPP system 102 may operate simultaneously according to the operations described with respect to FIG. 2 and FIG. 5. That is, the TTPP system 102 may have a direct biller relationship with some billers and operate according to FIG. 5 with those billers, whereas it may operate according to FIG. 2 with other billers with whom it does not have a direct biller relationship.

The following potential advantages may be provided by various embodiments described herein.

The TTPP system 102 provides the ability for the bill helpers to know that the money they are paying is going directly to the creditor (biller), rather than the bill owner, and is not being used for another purpose. This may foster the giving of more help than would otherwise be given.

The TTPP system 102 may increase the likelihood that billers are paid the money owed to them and therefore that the bill owners continue to receive the goods or services the billers provide.

Increasing the likelihood that billers are paid may in turn motivate billers to absorb some or all of the transaction costs associated with the payments, thereby reducing the cost of helping pay bills. This may foster the giving of more help than would otherwise be given.

The TTPP system 102 makes it easier for a person who needs help paying their bills (bill owner) to be found by people or organizations (bill helpers) that want to help the person in need. This may foster the giving of more help than would otherwise be given.

The TTPP system 102, because it does not require the bill helper to know or obtain the bill and biller information, reduces the time and energy the bill helper must expend in paying a bill owner's bill. This may foster the giving of more help than would otherwise be given.

The TTPP system 102, particularly embodiments in which the biller directly provides the bill information to the TTPP system 102, may increase the bill helper's confidence that bill amount is correct, i.e., that the need really exists. This may foster the giving of more help than would otherwise be given.

The TTPP system 102 may reduce the amount of embarrassment or shame involved in asking for help by the bill owners. This may foster the giving of more help than would otherwise be given.

The TTPP system 102 may enable to the bill helpers to understand the longer term needs of the bill owner and therefore more effectively plan to help the bill owner. This may foster the giving of more help than would otherwise be given.

The TTPP system 102 may reduce costs of helping pay bills relative to more traditional methods of helping. For example, the fees charged to use the TTPP system 102 may be less than the fees that must be paid in more traditional systems, such as money wire transfers, fees charged by bill paying entities, and so forth. This may foster the giving of more help than would otherwise be given.

The TTPP system 102 may enable bill helpers to pay bills for bill owners are who simply physically unable to pay their bills, e.g., due to a medical condition or being out of the country.

The TTPP system 102 may foster the sharing of payments by multiple bill helpers on a given bill, particularly since the bill helpers have more visibility into the fact that a portion of the bill is being paid by other bill helpers. For example, if a bill helper sees that $75 of a $100 bill has been paid, the bill helper may be willing to pay the remaining $25. This may foster the giving of more help than would otherwise be given.

Although embodiments have been described in which the bill selected by the bill helper to pay for the bill owner is money already owed by the bill owner to the biller, other embodiments are contemplated in which the “bill” selected is an account held by the bill owner into which the bill helper may deposit funds for the benefit of the bill owner. For example, the “bill” selected by the bill helper may be a pre-paid debit card account held by the bill owner into which the bill helper may deposit funds for the benefit of the bill owner. In this case, the “biller” is a debit card issuer, such as Akimbo, Walmart®, or other pre-paid debit card issuer. Preferably, the TTPP system 102 displays for bill helpers of the bill owner the balance on the debit card and the transactions (i.e., expenditures and deposits) made on the debit card to give bill helpers visibility into how the card is being used.

Although embodiments have been described in which the bill owner is known to the TTPP system 102 (i.e., the bill helper responds to an invitation to help a particular bill owner or the bill helper, e.g., organization or individual, selects a bill owner to help from a list of needy bill owners provided by the TTPP system 102), other embodiments are contemplated in which the “bill owner” is unknown to the TTPP system 102. Rather, the bill selected by the bill helper to fund is an account held by a biller into which the bill helper may deposit funds for the benefit of qualified “bill owners” that may draw from the biller's account if they have predetermined characteristics. For example, the biller may be a pharmacy into whose account bill helpers make “payments.” Subsequently, customers of the pharmacy needing medication may draw from the account at the pharmacy if they meet criteria established by the trusted third party and/or the pharmacy. The TTPP system 102 displays for bill helpers the balance in the account. Alternatively, the account is linked to a particular “bill owner” at the pharmacy, in which case the TTPP system 102 also displays for bill helpers of the bill owner the transactions (i.e., expenditures and deposits) made on the account, within limitations imposed by laws regarding the privacy of healthcare records.

### Multi-Benefactor Item Payment System

The network 100 embodiments described above are useful for helping bill helpers pay the bills of bill owners owed to billers. Embodiments are now described in which the TTPP system 102 is adapted to enable benefactors to work together to help purchase items for beneficiaries from merchants offering the items for sale. Such a TTPP system 102 provides a more complete solution for people needing help, since they typically not only owe bills but need items, i.e., goods and services, that they cannot or do not want to purchase by incurring debt such as occurs in the case of a bill. The benefactors may also be bill helpers, the beneficiaries may also be bill owners, and the merchants may also be billers.

An advantage of the TTPP system 102 is that it enables benefactors to collaborate to pay for items for beneficiaries while knowing that there will not be over-contribution for the item. A recent story may illustrate in hyperbole. A boy had his bicycle stolen and the story was reported in the local newspaper. Hundreds of people each contributed small amounts of money, and the total was in excess of ten times the amount needed to replace the bike. Although few people may receive media coverage for it, many people find themselves needing an item for which they cannot afford to pay, and they have family or friends who are willing to do so, particularly if they can join in with other people to get the item for the person in need. The TTPP system 102 embodiments described facilitate such philanthropy without the fear of over-contribution.

Referring now to FIG. 21, a block diagram illustrating a financial network 100 that includes a trusted third party payment (TTPP) system 102 according to an embodiment of the present invention is shown. The network 100 is similar in many ways to the network 100 of FIG. 1. However, FIG. 21 includes beneficiary devices 104, which may perform the operations of the bill owner devices 104 of FIG. 1 as described above in addition to the operations described below with respect to beneficiaries; FIG. 21 includes benefactor devices 106, which may perform the operations of the bill helper devices 106 of FIG. 1 as described above in addition to the operations described below with respect to benefactors; FIG. 21 includes merchant systems 108, which may perform the operations of the biller systems 108 of FIG. 1 as described above in addition to the operations described below with respect to merchants; FIG. 21 includes benefactor bank systems 116, which may perform the operations of the bill helper bank systems 116 of FIG. 1 as described above in addition to the operations described below with respect to benefactors; FIG. 21 includes merchant aggregator systems 122, which may perform the operations of the biller aggregator systems 122 of FIG. 1 as described above in addition to the operations of the merchant aggregator described below; and, FIG. 21 includes merchant bank systems 128, which may perform the operations of the biller bank systems 128 of FIG. 1 as described above in addition to the operations of the merchant bank systems described below.

The network 100 includes many computer systems and electronic devices in electronic communication with one another, that include: the TTPP system 102; beneficiary devices 104; benefactor devices 106; one or more merchant systems 108; an e-commerce gateway system 112; credit/debit card systems 114; benefactor bank systems 116; a merchant aggregator system 122; a “for benefit of” (FBO) account bank system 126; merchant bank systems 128; and a money transmitter system 132. Each of these systems is one or more computing devices capable of performing the functions described herein. For example, the systems may include, but are not limited to, a mainframe computer, mini-computer, super-computer, desktop computer, laptop computer, notebook computer, tablet computer, personal digital assistant, cell phone or other mobile device. Furthermore, each of the systems may be a combination of such computers in communication via a communications network, such as a local area network, wide area network, and/or telecommunications network. In one embodiment, the beneficiary devices 104 and the benefactor devices 106 execute a web browser that accesses web pages provided by the payment system 102. Additionally, the merchant systems 108 may execute a web browser that accesses web pages provided by the payment system 102.

The beneficiary devices 104, benefactor devices 106, merchant systems 108, e-commerce gateway systems 112, merchant aggregator systems 122, benefactor bank systems 116 and money transmitter system 132 are in communication with the TTPP system 102. The various bank systems—namely the credit/debit card systems 114, benefactor bank systems 116, FBO account bank system 126 and merchant bank systems 128—are in communication with one another. The e-commerce gateway systems 112 are in communication with the credit/debit card systems 114 and the benefactor bank systems 116. The money transmitter system 132 and merchant aggregator systems 122 are in communication with the TTPP system 102 and FBO account bank system 126. These various systems communicate via communications networks, such as local area networks, wide area networks, and/or telecommunications networks, such as the Internet, cell phone networks, or private telecommunications networks.

The beneficiaries operate the beneficiary devices 104 to provide to the TTPP system 102 information about merchants, items and potential benefactors that may be willing to help pay for the items. The benefactors operate the benefactor devices 106 to obtain from the TTPP system 102 information about the items desired by a beneficiary and to provide to the TTPP system 102 payment instrument information with which the benefactor will pay for the beneficiary items and to indicate which items and what amount for each item the benefactor is willing to pay. The merchants operate the merchant systems 108 in order to provide item catalog and item wish list information to the TTPP system 102, receive item payments serviced by the TTPP system 102, and provide purchased items to the beneficiaries. Additionally, the merchant systems 108 may provide to the TTPP system 102 beneficiary item information and track the progress of item payments via a dashboard provided by the TTPP system 102, e.g., to see how many requests have been sent out to potential benefactors for each item offered for sale by the merchant and to track payments made.

E-commerce gateway providers—also referred to as payment gateway providers or merchant service providers or other similar terms—operate the e-commerce gateway systems 112 to provide processing of credit card, debit card, and automatic clearing house (ACH) payments. The e-commerce gateway providers authorize payments and protect payment instrument information, such as credit/debit card or bank account information, by encrypting the information as it is passed between the TTPP system 102 and the payment processor. Examples of e-commerce gateway providers are Online Resources Corp. (ORCC), Credit Management Systems (CMS), Authorize.net, CyberSource, Chase Paymentech, Elavon, First Data Corporation and Global Payments, Inc. The credit/debit card systems 114 are systems operated by VISA®, MasterCard®, Novus®, and Centurion®, among others. Although FIG. 21 shows a single block as the e-commerce gateway systems 112 and a single block as the credit/debit card systems 114, it should be understood that multiple transaction processors might be involved in the transactions that flow between the TTPP system 102 and the benefactor bank system 116.

A merchant aggregator operates the merchant aggregator systems 122 to facilitate payments from the FBO account bank system 126 to the merchant bank systems 128. The merchant aggregator has relationships with multiple merchants who have authorized the merchant aggregator to receive payments on behalf of the merchants. Examples of merchant aggregators are Online Resources Corp. (ORCC), FiServ, Inc., Dun & Bradstreet and MasterCard RPPS. It should be understood that the network 100 might also include the larger banking system of a particular country, such as the Federal Reserve Bank system in the United States of America, and/or the international banking system.

The FBO (“For the Benefit Of”) account is a holding account in which funds are received from benefactor accounts at the benefactor bank systems 116 and from which funds are transmitted to merchant accounts at merchant bank systems 128. The trusted third party operates the TTPP system 102 to cause these transfers of funds into and out of the FBO account. The trusted third party is a money transmitter licensed by each of the jurisdictions, where required, from which it transfers money into the FBO account or to which it transfers money from the FBO account and/or is a sub-licensee or agent of a money transmitter having a money transfer license or money transmission license or money-transferring license (different jurisdictions have different terminology and requirements) from each of the jurisdictions and which operates the money transmitter system 132. The TTPP system 102 provides to the money transmitter system 132 a report that includes the information of all payments into the FBO account system 126. The money transmitter system 132 also receives a report from the FBO account system 126 of payments into and out of the FBO account. This enables the money transmitter to audit the transfers made by the TTPP system 102 into the FBO account, for example to detect money laundering or fraudulent transactions. Examples of money transmitters are PreCash Inc., ADP Payroll Services Inc., Amazon Payments Inc., Facebook Payments Inc., MoneyGram Payment Systems Inc., PayPal Inc., Western Union Financial Services Inc. and Xoom Corporation. As mentioned above, in an alternate embodiment the trusted third party is a licensed money transmitter, and the trusted third party, rather than a sub-licensor or principal money transmitter, holds the FBO account. In one embodiment, a first FBO account is maintained for money transfers in which the trusted third party is licensed as a money transmitter in all relevant jurisdictions, and a second FBO account is maintained for money transfers involving jurisdictions in which the trusted third party is a sub-licensee or agent of another money transmitter. The trusted third party is a distinct legal entity from the beneficiaries and benefactors; and, the beneficiary, not the trusted third party, receives the item from the merchant. In one embodiment, the trusted third party that developed and will soon operate the TTPP system 102 is Rumblelogic, Inc DBA PayTap, Inc. of Carrollton, Tex.

The TTPP system 102 includes hardware computer systems and software programs executed by the hardware systems to perform the functions described herein. The TTPP system 102 includes storage devices capable of storing data processed by the software programs and of storing the software programs themselves. Additionally, the trusted third party may provide mobile applications to operate on the beneficiary devices 104, benefactor devices 106 and/or the merchant systems 108.

The following use cases are envisioned for the TTPP system 102 described herein, although the uses are not limited to those listed.

An individual needing help paying for items may create an account on the TTPP system 102, enter item information (i.e., a wish list of items desired) and potential benefactor contact information and have the items paid for by benefactors via the TTPP system 102.

Merchants, who want to sell items, may be motivated to encourage their customers (beneficiaries) to use the TTPP system 102. For example, the merchant website may promote the TTPP system 102 and customer service representatives of the merchant may refer customers to the TTPP system 102 to get help paying for items from friends and family or other benefactors. Furthermore, as mentioned above, the merchant may be willing to pay the trusted third party a fee for the services provided by the TTPP system 102.

Parents and grandparents of college students may use the TTPP system 102 to identify critical and discretionary items and receive reminders from the TTPP system 102 to ensure the items are purchased in time.

Grown children of elderly parents may avoid the logistical difficulties of coordinating the payments by multiple siblings for different items and/or partial payments for a given item by using the TTPP system 102. Additionally, the adult children may enjoy the logistical benefits and simplicity of the TTPP system 102 to pay for their parents' items from the convenience of their benefactor devices 106 for their parents who have medical conditions that render them physically unable to pay for their items.

Community and charity groups organizing contributions to needy individuals and/or families may list the needed items on the TTPP system 102 and thereby enable their community of givers to easily select a beneficiary to help and to quickly and easily pay for an item and audit the payment for the beneficiary's items.

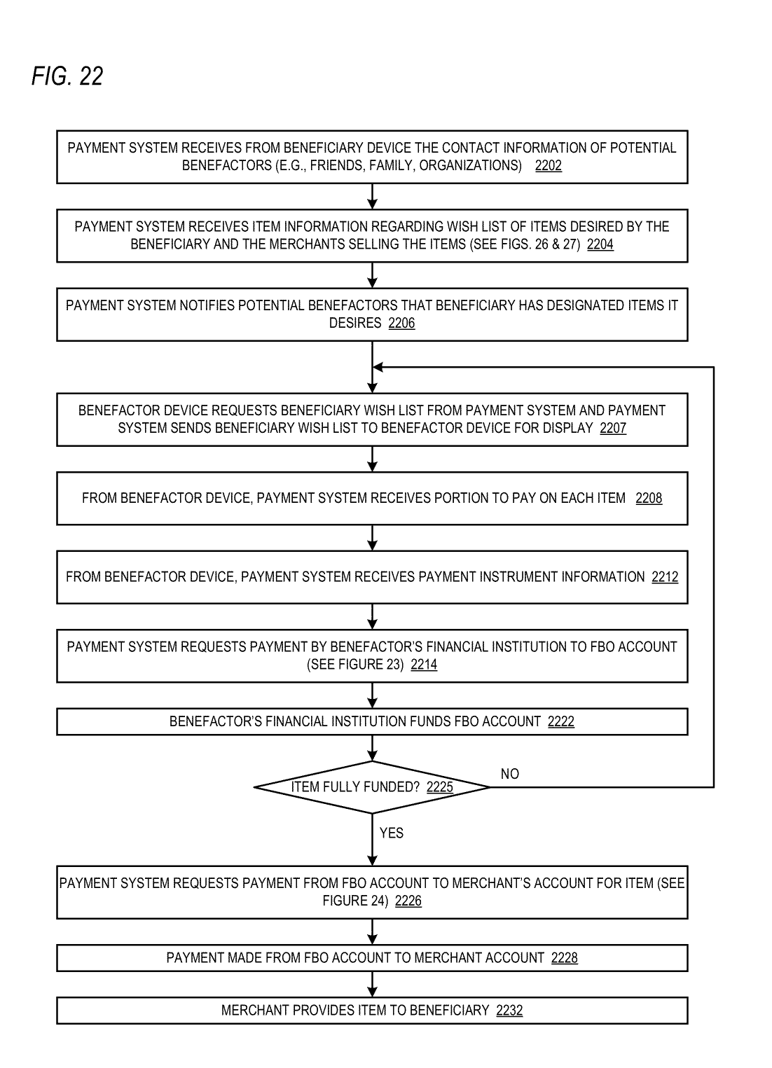

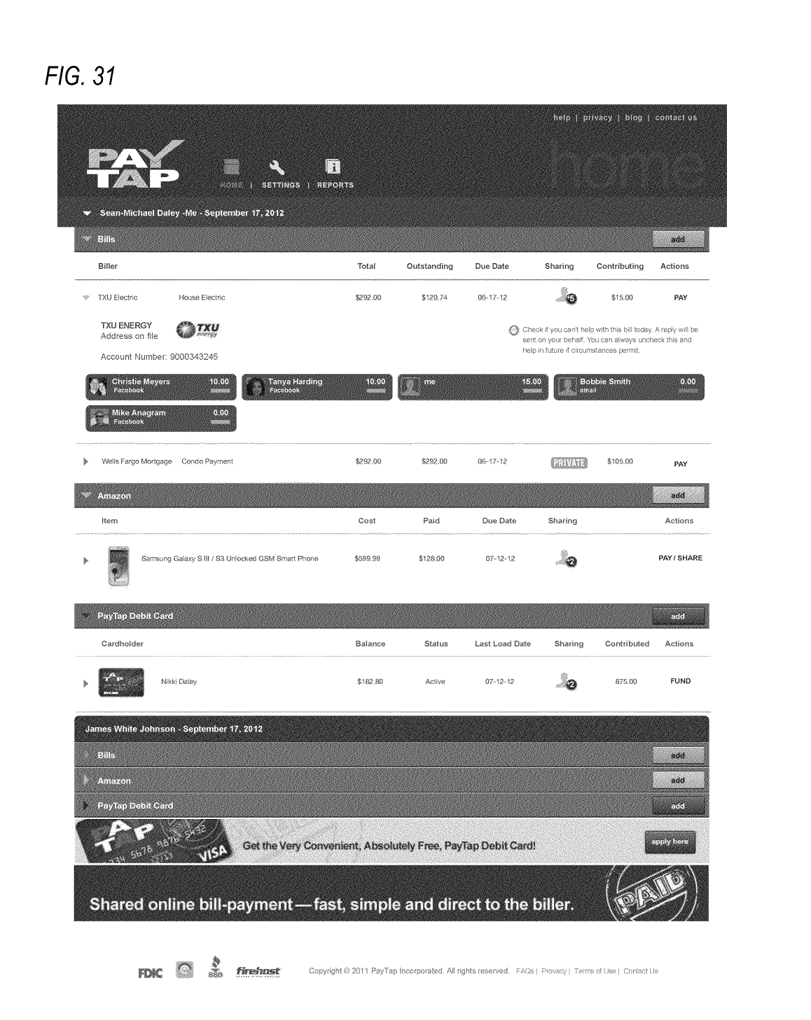

Referring now to FIG. 22, a flowchart illustrating operation of the TTPP system 102 of FIG. 1 to enable benefactors to pay for items desired by beneficiaries according to the present invention is shown. FIG. 31 is a screen shot illustrating a home web page provided by the TTPP system 102 for a user that is similar to the screen shot of FIG. 6B. The user interface provided by the TTPP system 102 according to the embodiment of FIG. 31, in addition to facilitating bill payments, enables a beneficiary to create a wish list of desired items offered for sale by merchants and enables benefactors to cooperatively pay for those items on behalf of the beneficiary. FIG. 31 shows an added portion in the middle of the screen—the portion set off by the horizontal bar with the label “Amazon”—below which items are listed that a beneficiary has added to his wish list, in particular a smart phone. The user, acting as a beneficiary, may click on the “SHARE” button associated with the item in order to share a request for the item with potential benefactors, as described in more detail below. Flow begins at block 2202.

At block 2202, the beneficiary accesses the TTPP system 102 using a beneficiary device 104. The TTPP system 102 receives information from each beneficiary that enables the TTPP system 102 to contact potential benefactors that the beneficiary thinks may be willing to help purchase items the beneficiary desires. In one embodiment, the TTPP system 102 provides a user interface on the beneficiary device 104 that enables the beneficiary to enter the name and email address of potential benefactors into the TTPP system 102, as shown in the screen shot of FIG. 7. Subsequently, the TTPP system 102 sends an email message to the potential benefactor's device 106 about the beneficiary's items. For example, the screen shot of FIG. 8 shows an email message that is similar to an email message sent at block 2702 to a potential benefactor regarding an item the beneficiary desires that includes the beneficiary's name, the item description and price, and a link the potential benefactor can click on to go to the TTPP system 102 to pay for the item, i.e., although the screen shot of FIG. 8 provides information regarding payment of a bill owed by the bill owner to a biller, the email sent according to block 2702 provides information regarding payment for an item the beneficiary desires that is offered for sale by a merchant. In one embodiment, the beneficiary may provide Facebook® account information to the TTPP system 102 to enable the TTPP system 102 to determine the beneficiary's Facebook friends. The TTPP system 102 user interface then displays the Facebook friends for the beneficiary, and the beneficiary clicks on the Facebook friends to add to the list of potential benefactors, as shown in the screen shot of FIG. 9. Subsequently, the TTPP system 102 sends a Facebook notification to the selected friends about the items the beneficiary desires. For example, the screen shot of FIG. 10 shows a Facebook notification on the Facebook page that is similar to a Facebook notification sent to a potential benefactor regarding an item the beneficiary desires, i.e., although the screen shot of FIG. 10 provides information regarding payment of a bill owed by the bill owner to a biller, the Facebook notification sent according to block 2702 provides information regarding payment for an item the beneficiary desires that is offered for sale by a merchant. In one embodiment, the user interface of the TTPP system 102 enables the beneficiary to link his Twitter account to the TTPP system 102 to share items with potential benefactors who are Twitter followers of the beneficiary, similar to the manner shown in the screen shot of FIG. 11. The TTPP system 102 subsequently sends a Twitter tweet, or message, as shown in the screen shot of FIG. 12, about the request for help to purchase an item via the TTPP system 102. In other embodiments, the TTPP system 102 may provide notifications to potential benefactors about the beneficiary's items via other social media outlets. Furthermore, the beneficiary may provide the cell phone number of potential benefactors so that the TTPP system 102 may send text messages to them about the beneficiary's desired items. Alternatively, the TTPP system 102 may receive potential benefactor contact information from the benefactors themselves. For example, a benefactor may be an individual or charitable organization that wants to help a beneficiary whom the benefactor does not even know. Flow proceeds to block 2204.

At block 2204, the TTPP system 102 receives information regarding a wish list of items desired by the beneficiary. The wish list includes information for each item that identifies the item and the merchant offering it for sale, including its price. Embodiments are described in more detail with respect to FIGS. 26 and 27 that involve this operation. Flow proceeds to block 2206.

At block 2206, the TTPP system 102 sends a message to the potential benefactors identified by the beneficiary using the contact information received at block 2202. The message indicates that the beneficiary has created a wish list of desired items and would like the benefactor to help pay for one or more of them. The TTPP system 102 may enable the beneficiary at block 2202 to create a customized message to be sent to the potential benefactors or to pick a stock message created by the TTPP system 102, such as an email message, Facebook notification or Twitter tweet. The message may also include information that enables the benefactor to access the TTPP system 102 in order to view the item information received at block 2204. For example, the message may include a link on which the benefactor may click which will take the potential benefactor to a website of the TTPP system 102. Email messages, Facebook notifications and Twitter tweets provided to the potential benefactor are similar to those shown in the example screen shots of FIGS. 8, 10 and 12, respectively, as discussed above with respect to block 2202, except the messages, notifications and tweets sent at block 2206 provide information regarding payment for an item the beneficiary desires that is offered for sale by a merchant rather than information regarding payment of a bill owed by the bill owner to a biller. Flow proceeds to block 2207.

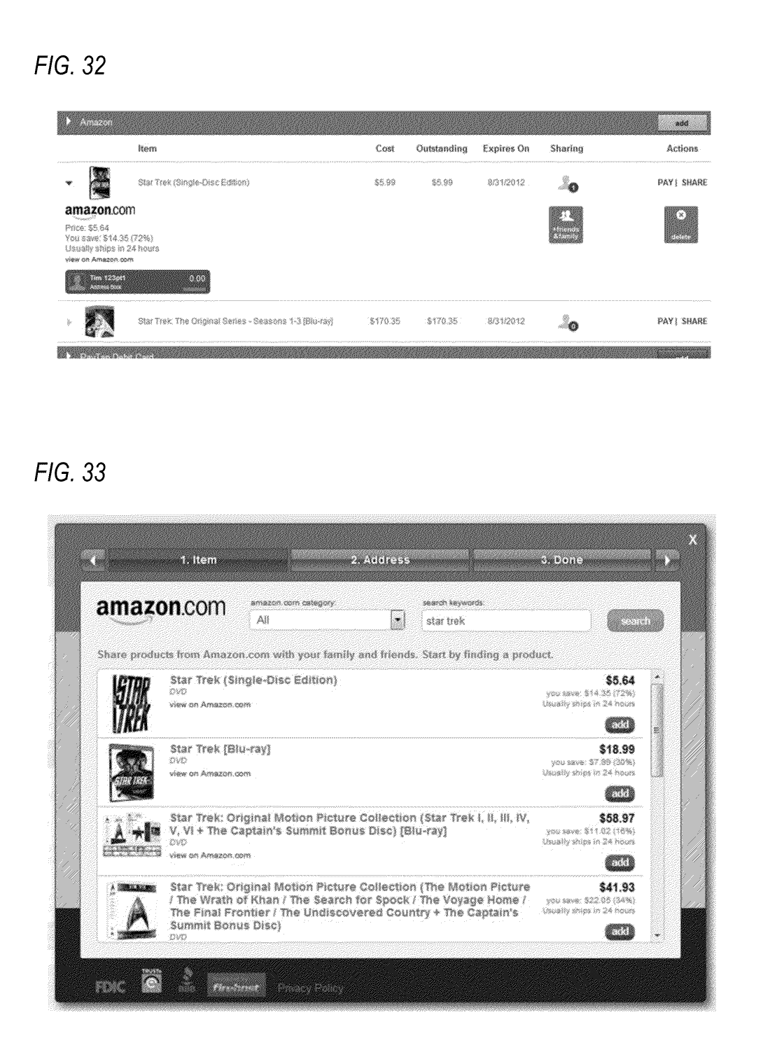

At block 2207, the benefactor uses his device 106 to make a request to the TTPP system 102 to view the wish list of items created by the beneficiary. In response to receiving the request from the benefactor device 106, the TTPP system 102 sends the benefactor device 106 the wish list information, which the benefactor device 106 displays for the benefactor. The wish list information includes information identifying the merchant and the price for which the merchant is selling each item desired by the beneficiary. FIG. 32 is a screen shot of a wish list displayed on the benefactor device 106 and beneficiary device 104 according to one embodiment of the user interface presented to the benefactor and beneficiary. The example wish list shown in FIG. 32 includes two items a beneficiary has selected and for each item, the item description, the item price, and the outstanding amount of the price of the item (i.e., the item price less the amount benefactors have already agreed to pay) are displayed. Flow proceeds to block 2208.

At block 2208, the benefactor picks one or more items to help pay for from the wish list, which the benefactor device 106 sends to the TTPP system 102. That is, the TTPP system 102 receives from the benefactor device 106, for each item the benefactor wants to help purchase, information that specifies the item and the portion of the item price the benefactor wants to pay. Preferably, the benefactor can make a full payment or a partial payment for the item, such as a percentage of the item or a partial dollar amount, similar to the manner shown in the screen shot of FIG. 17, except with respect to payment for an item the beneficiary desires that is offered for sale by a merchant rather than information regarding payment of a bill owed by the bill owner to a biller. In one embodiment, the TTPP system 102 enables the benefactor to specify a matching payment in which the benefactor pays an amount that matches the amount paid by other benefactors and/or the beneficiary himself. The matching payment may be contingent upon payment by the other payer or payers. In one embodiment, the TTPP system 102 enables the benefactor to specify that the item payment should be recurrent, such as for a regularly needed item. In one embodiment, as a benefactor makes a payment, the outstanding amount needed to purchase the item that is shown to benefactors is reduced by the amount paid. For example, the screen shot of FIG. 31 illustrates that although the total cost for the smart phone item is $599.99, benefactors have already agreed to pay $128.00 of the item price. Preferably, the TTPP system 102 does not allow a benefactor to pay more than the outstanding amount. Advantageously, this reduces the likelihood of benefactors overpaying for the item. Preferably, if the merchant makes a refund back to the TTPP system 102, the TTPP system 102 subsequently makes the refund back to the benefactor rather than to the beneficiary. Flow proceeds to block 2012.

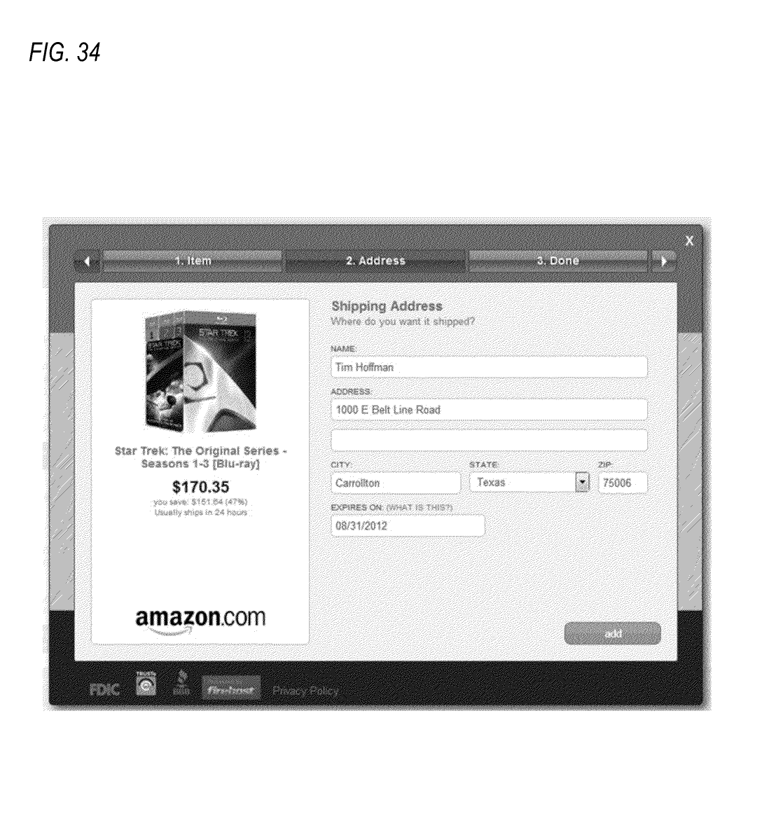

At block 2212, the TTPP system 102 receives from the benefactor device 106 payment instrument information of the benefactor. Preferably, the benefactor first selects a payment method, or payment instrument, such as a credit or debit card, checking or savings account (commonly referred to as an automatic clearing house (ACH) payment), or other payment method such as PayPal® or other “electronic wallet” online payment system, as shown in the screen shot of FIG. 18. (Although the screen shot of FIG. 18 refers to a bill owed, the user interface provided by the TTPP system 102 and displayed on the benefactor device 106 at block 2212 refers to an item to be purchased and a merchant offering the item for sale, rather than to a bill and a biller.) Once the benefactor selects a payment instrument, the TTPP system 102 calculates the fees that it will charge to the benefactor for the services provided and communicates fees to the benefactor, as shown in FIG. 34. The fees that may be charged include, but are not limited to, the following. The TTPP system 102 may charge a fee per item payment for the services provided by the TTPP system 102, which may be a fixed amount per item payment (e.g., one dollar, as shown in FIG. 34 or may be a percentage of the payment amount, for example. The TTPP system 102 may also pass on to the benefactor third party transaction fees (shown in FIG. 34 as $3.50) charged to the TTPP system 102 for paying for the item, such as transaction fees charged by the e-commerce gateway system 112, the credit/debit card company systems 114, and the merchant aggregator systems 122. Because the third party transaction fees incurred by the TTPP system 102 may vary with the payment instrument type, the fees passed on to the benefactor by the TTPP system 102 may also vary accordingly. If the benefactor does not accept the fees, the payment is cancelled. Otherwise, the TTPP system 102 proceeds with the payment process. According to other embodiments, the TTPP system 102 charges at least a portion of the fees to the merchant and/or beneficiary, rather than or in addition to the benefactor. After selecting a payment instrument, the benefactor provides information about the payment instrument. In the case of a credit/debit card, the payment instrument information may include the name of the card holder (i.e., the benefactor), the card number, the expiration date, security code and mailing address, as shown in the screen shot of FIG. 19. In the case of an ACH payment, the payment instrument information may include the routing number of the bank 116 at which the account is held, the account number and the name of the account holder (i.e., the benefactor). In the case of a PayPal payment, preferably the TTPP system 102 directs the benefactor to the PayPal website where the benefactor makes a PayPal payment to the trusted third party's PayPal account. Flow proceeds to block 2214.

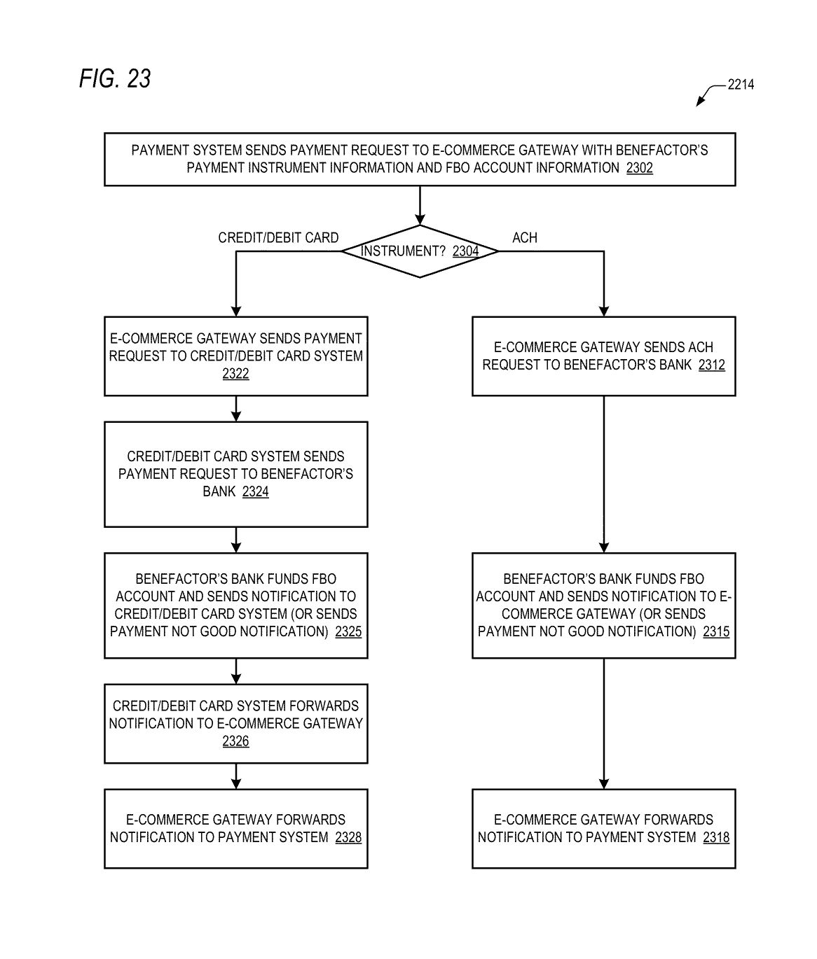

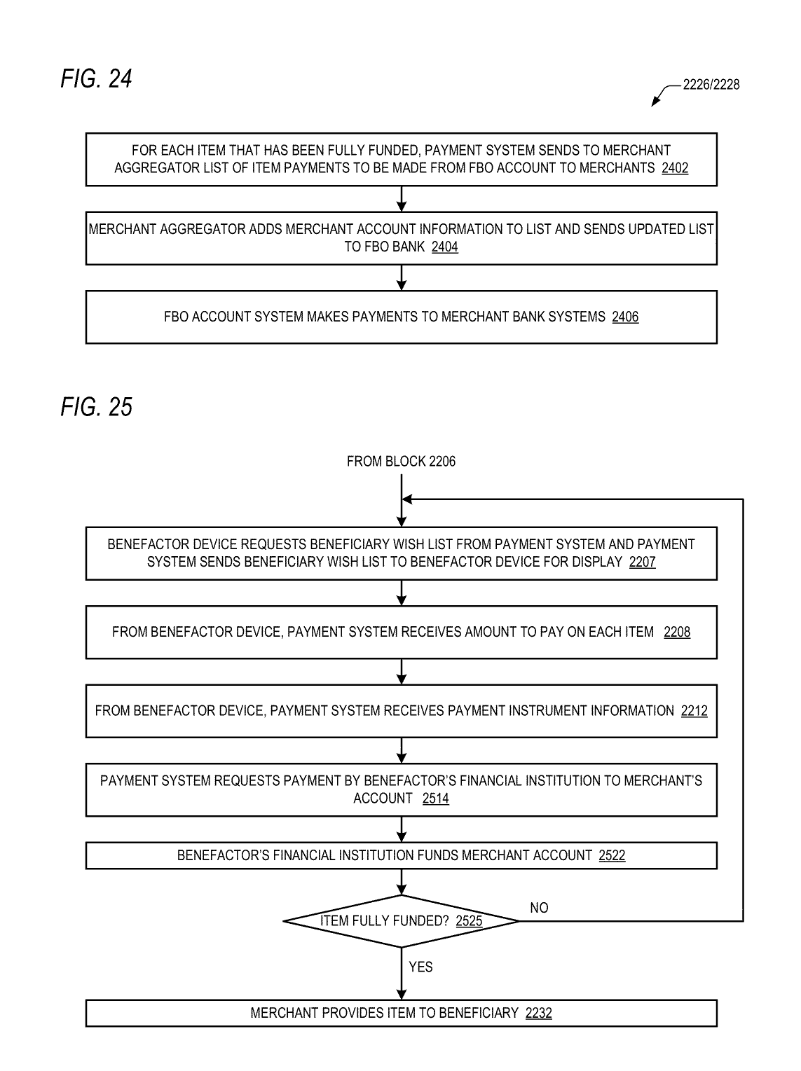

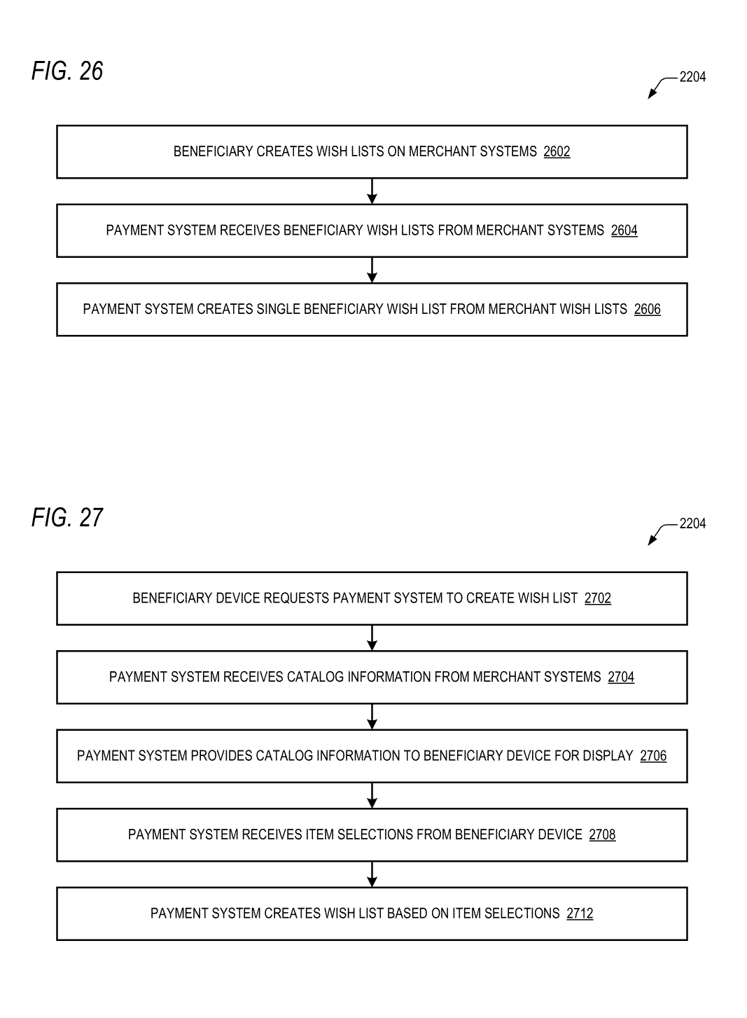

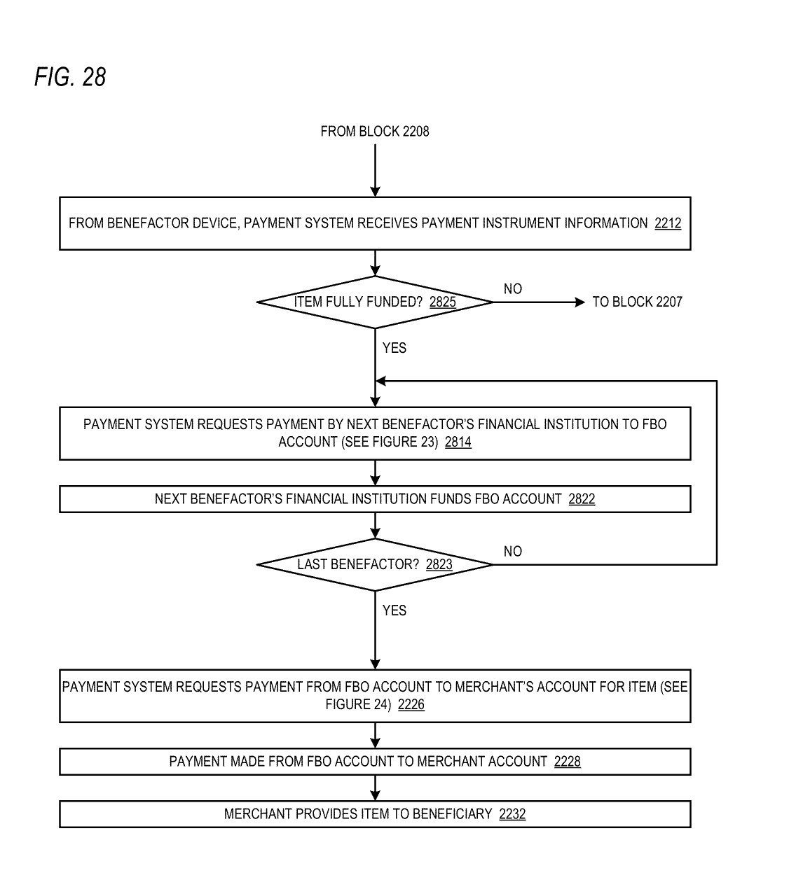

At block 2214, the TTPP system 102 requests that payment be made by the benefactor's financial institution 116 to the FBO account at the FBO account bank system 126. Preferably, the payment request includes a payment amount that is equal to the sum of the amount the benefactor indicated it would pay on the item of the beneficiary at block 2208 and the fee communicated at block 2212. The operation of block 2214 is described in more detail below with respect to FIG. 23. Although not shown, the TTPP system 102 also determines whether the payment is good (similar to the operation performed at block 216 of FIG. 2). If not, the TTPP system 102 cancels the payment and notifies the benefactor (similar to the operation performed at block 218 of FIG. 2); if so, the TTPP system 102 provides a receipt to the benefactor (similar to the operation performed at block 224 of FIG. 2). Flow proceeds to block 2222.

At block 2222, the benefactor bank system 116 funds the FBO account 126. Preferably, the benefactor bank system 116 makes an electronic transfer of funds to the FBO account 126. Flow proceeds to decision block 2225.

At decision block 2225, the TTPP system 102 determines whether the item has been fully funded. That is, the TTPP system 102 determines whether the sum of the amounts that each of the benefactors has agreed to pay at block 2208 has reached the item price. If so, flow proceeds to block 2226; otherwise, flow returns to block 2207.

At block 2226, the TTPP system 102 requests payment from the FBO account to the merchant account at the merchant bank system 128. In one embodiment, many payments are made at block 2222 over the course of a day into the FBO account from many different benefactor financial accounts for many different items for many different beneficiaries that accumulate in the FBO account. The accumulated payments may be of various types, as described above, e.g., credit/debit cards, ACH payments, PayPal payments. In one embodiment, in the case of an ACH payment, the TTPP system 102 may wait a few days after the benefactor authorizes payment on an item to pay the merchant bank system 128 in order to reduce the likelihood that the funds from the benefactor account bank system 116 are not available (e.g., the account was overdrawn or closed). Thus, if the benefactor chooses an ACH payment instrument at block 212 and the due date is within the number of days the TTPP system 102 waits to pay for the item, the TTPP system 102 gives the benefactor the opportunity to pay by another method. As described above, multiple benefactors may each provide funds that are a portion of the sales price of the item; therefore, the TTPP system 102 keeps track of the total amount that has been collected for an item (i.e., for which funds have been received according to block 2222), and in response to detecting that the total amount has reached the sales price of the item, the TTPP system 102 requests payment from the FBO account to the merchant's account. In an alternate embodiment in which the merchant allows partial payments, similar to the manner in which “lay-away” arrangements operate, the TTPP system 102 makes partial payments from the FBO account to the merchant account even if the total amount collected from the beneficiaries has not yet reached the sales price. Alternatively, a single benefactor may provide the funds for the entire sales price of the item. Additionally, the beneficiary himself may provide some of the funds for the item. The operation of block 2226 is described in more detail below with respect to FIG. 24. Flow proceeds to block 2228.

At block 2228, a payment is made from the FBO account to the merchant account at the merchant bank system 128. The operation of block 2228 is also described below with respect to FIG. 24. Flow proceeds to block 2232.

At block 2232, the merchant provides the item to the beneficiary. The merchant may ship the item to the beneficiary using shipping information provided to the merchant system 108 by the TTPP system 102 or by the beneficiary, such as shown in the screen shot of FIG. 34, or the beneficiary may pick up the item at the merchant's store. Flow ends at block 2232.

Although portions of FIG. 22 may describe the flow through the TTPP system 102 of a single payment of a portion of a single item by a single benefactor of a single beneficiary to a single merchant, it should be understood that one or more beneficiaries may each specify one or more items desired from one or more merchants to the TTPP system 102, and one or more benefactors may pay for one or more items for one or more beneficiaries via the TTPP system 102. As may be observed from the description herein, the TTPP system 102 advantageously enables multiple benefactors to contribute to paying for multiple items which are offered for sale by different merchants for a beneficiary, and for some of the items multiple benefactors may each pay a portion of the single item price. Furthermore, embodiments are contemplated in which the merchant is the entity operating the TTPP system 102.

Referring now to FIG. 23, a flowchart illustrating in more detail the operation at block 2214 of FIG. 22 according to one embodiment of the present invention is shown. Flow begins at block 2302.

At block 2302, the TTPP system 102 sends a payment request to the e-commerce gateway system 112 with the payment amount obtained at block 2208 (including fees, as described herein), the benefactor payment instrument information obtained at block 2212 and the FBO account information. If the benefactor elects to pay using an online payment service, such as PayPal, the TTPP system 102 redirects the benefactor's device 106 to the PayPal website where the benefactor makes a payment to the PayPal account of the trusted third party and receives a payment confirmation from the PayPal system. Subsequently, the TTPP transfers the payment amount (less fees) to the FBO account bank system 126. Flow proceeds to decision block 2304.

At decision block 2304, if the payment instrument is a credit/debit card, flow proceeds to block 2322; otherwise, if an ACH transaction, e.g., checking or savings account, flow proceeds to block 2312.

At block 2312, in response to receiving the request sent at block 2302, the e-commerce gateway system 112 sends to the benefactor bank system 116 an ACH request to transfer funds from the benefactor's checking or savings account to the FBO account. Flow proceeds to block 2315.

At block 2315, in response to receiving the request sent at block 2312, the benefactor bank system 116 funds the FBO account from the benefactor's account and sends a notification to the e-commerce gateway system 112 that the payment was made, or sends a notification that the payment was not good (e.g., insufficient funds, credit limit exceeded). Flow proceeds to block 2318.

At block 2318, the e-commerce gateway system 112 forwards the notification sent by the benefactor bank system 116 at block 2315 to the TTPP system 102. Flow ends at block 2318.

At block 2322, in response to receiving the request sent at block 2302, the e-commerce gateway system 112 sends to the credit/debit card system 114 a request to transfer funds from the benefactor's credit/debit card account to the FBO account. Flow proceeds to block 2324.

At block 2324, in response to receiving the request sent at block 2322, the credit/debit card system 114 sends to the benefactor bank system 116 (i.e., the bank that issued the credit/debit card to the benefactor) a request to transfer funds from the benefactor's credit/debit card account to the FBO account. Flow proceeds to block 2325.

At block 2325, in response to receiving the request sent at block 2324, the benefactor bank system 116 funds the FBO account from the benefactor's credit/debit account and sends a notification to the credit/debit card system 114 that the payment was made, or sends a notification that the payment was not good. Flow proceeds to block 2326.

At block 2326, the credit/debit card system 114 forwards the notification sent by the benefactor bank system 116 at block 2325 to the TTPP system 102. Flow proceeds to block 2328.

At block 2328, the e-commerce gateway system 112 forwards the notification forwarded by the credit/debit card system 114 at block 2326 to the TTPP system 102. Flow ends at block 2328.

Referring now to FIG. 24, a flowchart illustrating in more detail the operation at blocks 2226 and 2228 of FIG. 22 according to one embodiment of the present invention is shown. Flow begins at block 2402.

At block 2402, the TTPP system 102 sends to the merchant aggregator system 122 a list of item payments to be made from the FBO account to the various merchant bank systems 128. As discussed herein, the merchant may agree to pay the trusted third party a fee per item payment for the benefits provided by the TTPP system 102, in which case the TTPP system 102 deducts the fee from the amount of the item payment from the FBO account to the merchant. Furthermore, as discussed herein, the merchant may agree to pay to the trusted third party transaction processing fees, or a portion thereof, associated with a given item payment, in which case the TTPP system 102 deducts the fee from the amount of the item payment from the FBO account to the merchant. Additionally, for merchants who accept partial payments (according to the lay-away plan), the TTPP system 102 may cause partial payments of a given item to be made from the FBO account to the merchant. Flow proceeds to block 2404.

At block 2404, the merchant aggregator system 122, which has the account information for each merchant, takes the list received from the TTPP system 102 at block 2402 and adds the merchant's account information to each item payment. The merchant aggregator system 122 then sends the updated list to the FBO account bank system 126. In one embodiment, the merchant aggregator system 122 sends a file, referred to as a “FED-ready file,” that includes a list of single line entry ACH debit transactions to be made from the FBO account system 126 to the merchant bank systems 128. The item aggregator system 122 may consolidate payments to the same merchant. In one embodiment, if the merchant is one for which the TTPP system 102 does not have the information necessary to make an electronic funds transfer to the merchant bank system 128, the merchant aggregator system 122 generates a physical check and mails it to the merchant with information identifying the item to be purchased, the beneficiary and the beneficiary's shipping information. Flow proceeds to block 2406.

At block 2406, the FBO account bank system 126 makes the item payments specified in the list sent at block 2404 to the merchant bank systems 128. In one embodiment, the merchant's bank system 128 application programming interface (API) provides a remote procedure call that the TTPP system 102 may make to associate each payment with the item being paid for and to provide identification and shipping information of the beneficiary, which will enable the merchant systems 108 to associate the payments with the correct items and beneficiaries. Alternatively, the TTPP system 102 may provide an API that allows the merchant systems 108 to pull the payment-to-item/beneficiary association information from the TTPP system 102, such as on a periodic basis. In other embodiments, the TTPP system 102 may provide a file (e.g., spreadsheet) to the merchant systems 108 by various means (e.g., FTP transfer, email attachment, shared document, binary queue message) that includes the payment-to-item/beneficiary association information. Flow ends at block 2406.

Referring now to FIG. 25, a flowchart illustrating operation of the TTPP system 102 of FIG. 21 to facilitate payment to merchants for beneficiary items by benefactors according to an alternate embodiment of the present invention is shown. In the embodiment of FIG. 25, the merchant has a relationship with the trusted third party such that the TTPP system 102 facilitates direct transfers from the benefactor bank system 116 to the merchant bank system 128 rather than indirectly through the FBO account. FIG. 25 is similar to FIG. 22 and like-numbered blocks indicate like operations. For simplicity, blocks 2202 through 2206 are not shown; blocks 2226 and 2228 are not included; block 2214 is replaced by block 2514; and block 2222 is replaced by block 2522. Flow proceeds from block 2206 to blocks 2207, 2208, 2212 and 2514.

At block 2514, the TTPP system 102 requests that payment be made by the benefactor's financial institution to the merchant's account at the merchant bank system 128. Preferably, the TTPP system 102, which is in communication with the benefactor's bank system 116, sends a request to the benefactor's bank system 116 to make an electronic transfer of funds from the benefactor's account to the merchant's account at the merchant's bank system 128. Processing of the request made at block 2514 is similar in some ways to the processing described with respect to FIG. 23, except that the merchant's account at the merchant bank system 128 is the target of the payment rather than the FBO account. That is, the merchant has provided its merchant ID to the TTPP system 102 and has authorized the TTPP system 102 to accept payments on its behalf. Furthermore, as described above, in one embodiment the merchant is the entity operating the TTPP system 102. Flow proceeds to block 2522.

At block 2522, the benefactor bank system 116 funds the merchant's account in the merchant bank system 128. As described above, preferably the merchant's bank system 128 API provides a remote procedure call that the TTPP system 102 may make to associate each payment with the item being paid for and to provide identification and shipping information of the beneficiary, which will enable the merchant systems 108 to associate the payments with the correct items and beneficiaries. Alternatively, the TTPP system 102 may provide an API that allows the merchant systems 108 to pull the payment-to-item/beneficiary association information from the TTPP system 102, such as on a periodic basis. In other embodiments, the TTPP system 102 may provide a file (e.g., spreadsheet) to the merchant systems 108 by various means (e.g., FTP transfer, email attachment, shared document, binary queue message) that includes the payment-to-item/beneficiary association information. Flow proceeds to decision block 2525.

At decision block 2525, the TTPP system 102 determines whether the item has been fully funded. That is, the TTPP system 102 determines whether the sum of the amounts that have been paid from all of the benefactors to the merchant account at block 2522 has reached the item price. If so, flow proceeds to block 2232; otherwise, flow returns to block 2207.

At block 2232, the merchant provides the item to the beneficiary. Flow ends at block 2232.

Although portions of FIG. 25 may describe the flow through the TTPP system 102 of a single payment of a portion of a single item by a single benefactor of a single beneficiary to a single merchant, it should be understood that one or more beneficiaries may each specify one or more items desired from one or more merchants to the TTPP system 102, and one or more benefactors may pay for one or more items for one or more beneficiaries via the TTPP system 102. As may be observed from the description herein, the TTPP system 102 advantageously enables multiple benefactors to contribute to paying for multiple items which are offered for sale by different merchants for a beneficiary, and for some of the items multiple benefactors may each pay a portion of the single item price. Furthermore, embodiments are contemplated in which the merchant is the entity operating the TTPP system 102 such that payments are made directly from the benefactor financial institution to the merchant financial institution similar to the manner described with respect to the embodiment of FIG. 25.

It should be understood that the TTPP system 102 may operate simultaneously according to the operations described with respect to FIG. 22 and FIG. 25. That is, the TTPP system 102 may have a direct merchant relationship with some merchants and operate according to FIG. 25 with those merchants, whereas it may operate according to FIG. 22 with other merchants with whom it does not have a direct merchant relationship.

Referring now to FIG. 26, a flowchart illustrating in more detail the operation of the TTPP system 102 of FIG. 21, including the operation at block 2204 of FIG. 22, according to one embodiment of the present invention is shown. According to the embodiment of FIG. 26, the beneficiary creates a wish list on one or more merchant systems 108, and the TTPP system 102 obtains the wish lists from the merchant systems and combines them into a composite, or final, wish list of the beneficiary that may be provided to the benefactors to enable the benefactors to select items from the wish list that they want to help pay for. Flow begins at block 2602.

At block 2602, the beneficiary creates a wish list on each of one or more merchant systems 108. For example, the beneficiary may create a wish list on the Amazon.com, BN.com (Barnes & Noble) and/or Walmart.com websites, among other merchants that provide the ability to create lists of items desired by a beneficiary. Flow proceeds to block 2604.

At block 2604, the TTPP system 102 receives the information specifying the wish lists from each of the merchant systems 108 on which the beneficiary created a wish list at block 2602. In one embodiment, the wish list information includes an item identifier (e.g., SKU number, merchant item number, model number) for each item in the list and its price. Additionally, the wish list information may include a description of the item (e.g., photos and technical specifications), reviews of the item, and availability information of each item (e.g., inventory on hand for shipping and/or for store pickup) and the location of stores that have the item in stock. Preferably, the merchant system 108 provides an interface, such as an API, to the TTPP system 102 that enables the TTPP system 102 to request and obtain the beneficiary wish list information. In one embodiment, the API includes a remote procedure call in which the TTPP system 102 provides a token associated with the beneficiary's account on the merchant's website and a request for the wish list associated with the token, and in response the merchant system 108 provides the associated beneficiary's wish list information. For example, the merchant website may employ the widely used open standard OAuth 2.0 authorization service. For example, the TTPP system 102 user interface may provide a button that the beneficiary may click on to log in to the merchant's website (i.e., provide his user credentials), and the merchant system 108 may in response provide to the TTPP system 102 a token that the TTPP system 102 may use to specify the beneficiary in remote procedure calls. Alternatively, the TTPP system 102 may provide an API that allows the merchant systems 108 to push the wish list information to the TTPP system 102 on a periodic basis. The merchant systems 108 may push the wish list for each of multiple beneficiaries identified by the TTPP system 102 to the merchant systems 108. In other embodiments, the TTPP system 102 may receive a file (e.g., spreadsheet) from the merchant systems 108 by various means (e.g., FTP transfer, email attachment, shared document, binary queue message) that includes the wish list information. The TTPP system 102 may also receive from the merchant systems 108 other necessary information, such as identification and shipping information of the beneficiary and identification and financial institution information about the merchant. In one embodiment, the user interface provides for the beneficiary a pick list of merchants known to the TTPP system 102 from which the TTPP system 102 may obtain beneficiary wish lists. Flow proceeds to block 2606.

At block 2606, the TTPP system 102 accumulates the various wish lists obtained at block 2604 into a single wish list of the beneficiary. The wish list may then subsequently be provided to the benefactor device 106 at block 2207 to enable the benefactor to select an item to pay for the sake of the beneficiary at block 2208. Additionally, the wish list may subsequently be provided to the beneficiary device 104 to enable the beneficiary to view and/or modify the wish list. The example wish list shown in FIG. 32 includes two items a beneficiary has selected and for each item, the item description, the item price, and the outstanding amount of the price of the item (i.e., the item price less the amount benefactors have already agreed to pay) are displayed. Flow ends at block 2606.

Referring now to FIG. 27, a flowchart illustrating in more detail the operation of the TTPP system 102 of FIG. 21, including the operation at block 2204 of FIG. 22, according to an alternate embodiment of the present invention is shown. According to the embodiment of FIG. 27, the TTPP system 102 obtains from one or more of the merchant systems 108 catalog information of items offered for sale by the merchant and provides the catalog information to the beneficiary. The beneficiary selects items from the catalog to create a wish list on the TTPP system 102. The wish list may then be provided to the benefactors to enable the benefactors to select items from the wish list that they want to help pay for. Flow begins at block 2702.

At block 2702, the beneficiary operates the beneficiary device 104 to send the TTPP system 102 a request to create a wish list, which the TTPP system 102 receives. In the embodiment of the user interface presented to the beneficiary illustrated in the screen shot of FIG. 31, the beneficiary may click on the “add” button at the far right of the bar that includes the “Amazon” drop down button in order to see a catalog of items, such as shown in the screen shot of FIG. 33, from which the beneficiary may select a desired item to place into his wish list. Flow proceeds to block 2074.

At block 2704, the TTPP system 102 receives catalog information from one or more merchant systems 108. The catalog information specifies items offered for sale by the merchant. The information specified for each item may include an item identifier, price, description, reviews, and availability information. In one embodiment, the catalog information includes not only items sold by the merchant who operates the merchant system 108 from which a particular catalog is obtained, but may also include items sold by partners of the merchant who project their catalog item information through the merchant, such as Amazon.com partners, for example. In one embodiment, the TTPP system 102 obtains the catalog information from the merchant systems 108 in a dynamic fashion. That is, the TTPP system 102 obtains fresh catalog information in response to the beneficiary's request at block 2702. This embodiment has the advantage of providing the most recent catalog information to the beneficiary. In an alternate embodiment, the TTPP system 102 periodically obtains the catalog information from the merchant systems 108 and retains it in local storage. This embodiment has the advantage of potentially being able to provide the catalog information to the beneficiary more quickly. Preferably, the merchant system 108 provides an interface, such as an API, to the TTPP system 102 that enables the TTPP system 102 to request and obtain the catalog information. Alternatively, the TTPP system 102 may provide an API that allows the merchant systems 108 to push the catalog information to the TTPP system 102 on a periodic basis. Preferably, the TTPP system 102 allows the beneficiary to provide search criteria to the TTPP system 102 for particular items, which reduces the amount of catalog information the TTPP system 102 must provide to the beneficiary device 104 (at block 2706 below). For example, in the screen shot shown in FIG. 33, the beneficiary has searched for items using the keywords “star trek,” to narrow down the list of items to select into the wish list. In one embodiment, the TTPP system 102 may provide the search criteria to the merchant systems 108 when requesting the catalog information in order to reduce the amount of catalog information the TTPP system 102 must receive from the merchant systems 108. Flow proceeds to block 2706.

At block 2706, the TTPP system 102 provides the catalog information obtained at block 2704 to the beneficiary device 104, which the benefactor device 106 displays for the beneficiary. FIG. 33 is a screen shot of the catalog of items displayed on the beneficiary device 104 according to one embodiment of the user interface presented for the beneficiary to enable the beneficiary to create the wish list, i.e., to select desired items from the catalog (at block 2708 below). In the user interface shown in the screen shot of FIG. 33, the price and description for each item is displayed. The beneficiary may click on the “add” button associated with an item in order to add the item to the beneficiary's wish list. Flow proceeds to block 2708.

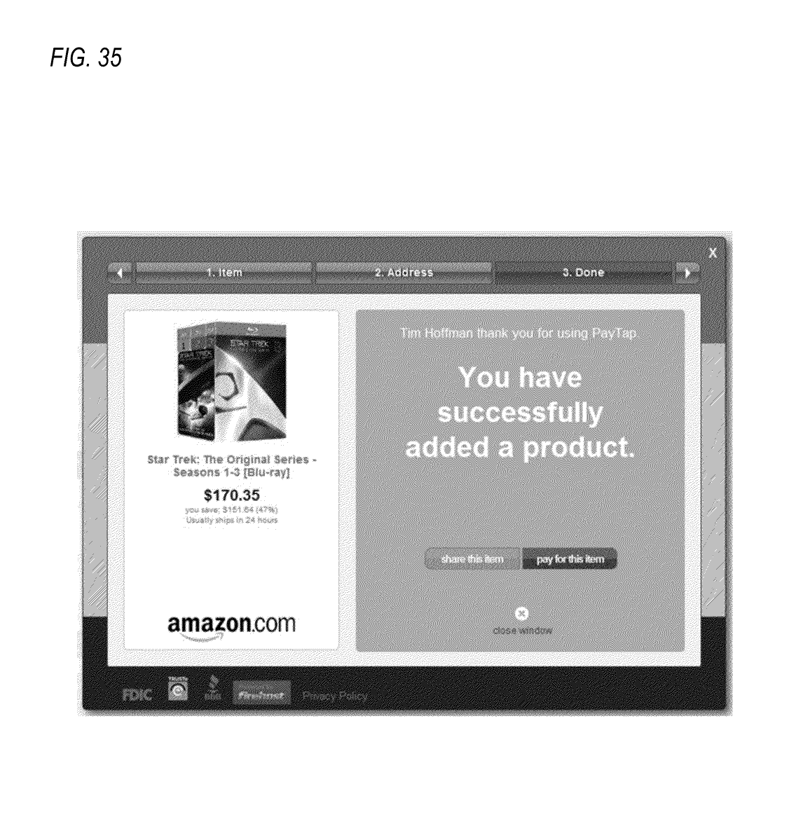

At block 2708, the beneficiary uses the beneficiary device 104 to select desired items from the catalog of items displayed at block 2706. In response, the beneficiary device 104 provides the selection information to the TTPP system 102. In the user interface shown in the screen shot of FIG. 33, the beneficiary may click on the “add” button associated with an item in order to add the item to the beneficiary's wish list. The beneficiary may also enter shipping information associated with the item, as shown in the screen shot of FIG. 34. FIG. 35 is a screen shot of a message displayed on the beneficiary device 104 to confirm to the beneficiary that an item has been successfully added to the wish list according to one embodiment. As shown in the screen shot of FIG. 35, once the item has been added to the wish list, the beneficiary may click on the “share this item” button to share the item with potential benefactors. As also shown in the screen shot of FIG. 35, the beneficiary may also click on the “pay for this item” to pay for a portion of the item himself. Flow proceeds to block 2712.

At block 2712, in response to and based on the selection information received at block 2708, the TTPP system 102 creates a wish list of items for the beneficiary. The wish list may then subsequently be provided to the benefactor device 106 at block 2207 to enable the benefactor to select an item to pay for the sake of the beneficiary at block 2208. Additionally, the wish list may subsequently be provided to the beneficiary device 104 to enable the beneficiary to view and/or modify the wish list. FIG. 32 is a screen shot of a wish list displayed on the benefactor device 106 or beneficiary device 104 according to one embodiment of the user interface presented to the benefactor and beneficiary, as discussed above. Flow ends at block 2712.

Referring now to FIG. 28, a flowchart illustrating operation of the TTPP system 102 of FIG. 21 to enable benefactors to pay for items desired by beneficiaries according to an alternate embodiment of the present invention is shown. In the alternate embodiment of FIG. 28, the TTPP system 102 waits to effect the transfer of funds from the beneficiary account to the FBO account until the item price has been fully funded. The flowchart is similar to the flowchart of FIG. 22 and like-numbered blocks indicate like operations. For simplicity, blocks 2202 through 2208 are not shown, and flow proceeds from block 2212 to decision block 2825. Other differences will now be described.

At decision block 2825, the TTPP system 102 determines whether the item has been fully funded. That is, the TTPP system 102 determines whether the sum of the amounts that each of the benefactors has agreed to pay at block 2208 has reached the item price. If so, flow proceeds to block 2814; otherwise, flow returns to block 2207.

At block 2814, the TTPP system 102 requests that payment be made by the benefactor's financial institution 116 to the FBO account at the FBO account bank system 126, as described above with respect to block 2214, for the next benefactor in the list of benefactors that has agreed to pay for the item at block 2208. Flow proceeds to block 2822.

At block 2822, the benefactor bank system 116 funds the FBO account 126, as described above with respect to block 2222, for the next benefactor in the list of benefactors that has agreed to pay for the item at block 2208. Flow proceeds to decision block 2823.

At block 2823, the TTPP system 102 determines whether a fund transfer has been effected for all the benefactors who agreed to pay for the item at block 2208. If so, flow proceeds to block 2226; otherwise, flow returns to block 2814 to effect a transfer for the next benefactor. Flow continues from block 2226 to block 2228 and to block 2232 as described above with respect to FIG. 22.

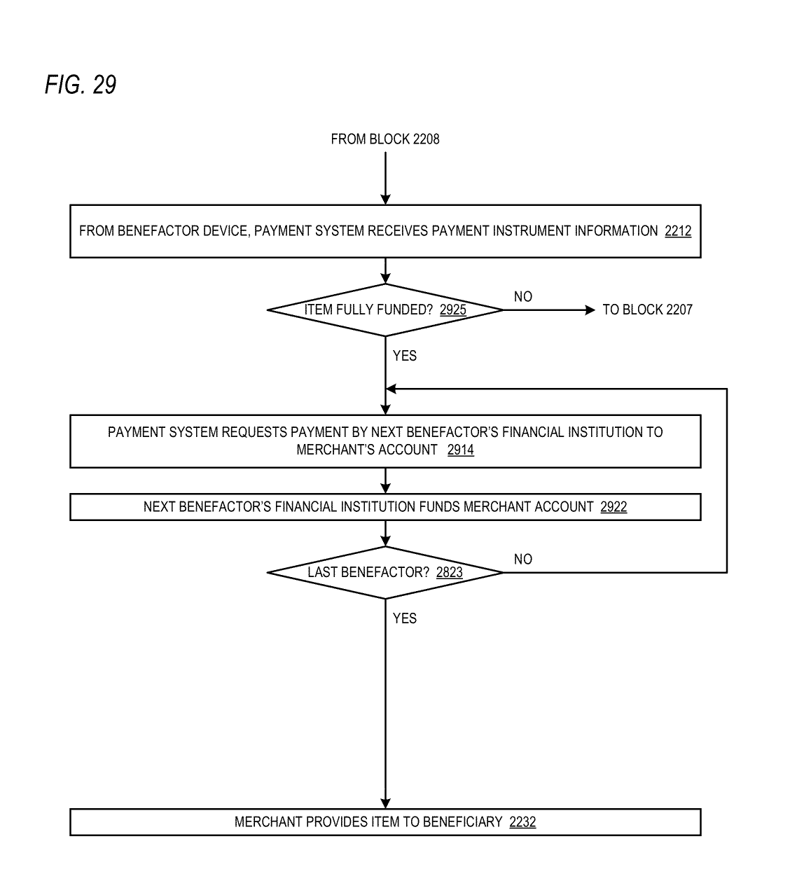

Referring now to FIG. 29, a flowchart illustrating operation of the TTPP system 102 of FIG. 21 to enable benefactors to pay for items desired by beneficiaries according to an alternate embodiment of the present invention is shown. In the alternate embodiment of FIG. 29, the TTPP system 102 waits to effect the transfer of funds from the beneficiary accounts to the merchant account until the item price has been fully funded. The flowchart is similar to the flowchart of FIG. 25 and like-numbered blocks indicate like operations. For simplicity, blocks 2202 through 2208 are not shown, and flow proceeds from block 2212 to decision block 2925. Other differences will now be described.

At decision block 2925, the TTPP system 102 determines whether the item has been fully funded. That is, the TTPP system 102 determines whether the sum of the amounts that each of the benefactors has agreed to pay at block 2208 has reached the item price. If so, flow proceeds to block 2914; otherwise, flow returns to block 2207.

At block 2914, the TTPP system 102 requests that payment be made by the benefactor's financial institution 116 to the merchant's account at the merchant bank system 128, as described above with respect to block 2514, for the next benefactor in the list of benefactors that has agreed to pay for the item at block 2208. Flow proceeds to block 2922.

At block 2922, the benefactor bank system 116 funds the merchant account 126, as described above with respect to block 2522, for the next benefactor in the list of benefactors that has agreed to pay for the item at block 2208. Flow proceeds to decision block 2823.

At block 2823, the TTPP system 102 determines whether a fund transfer has been effected for all the benefactors who agreed to pay for the item at block 2208. If so, flow proceeds to block 2232; otherwise, flow returns to block 2914 to effect a transfer for the next benefactor.

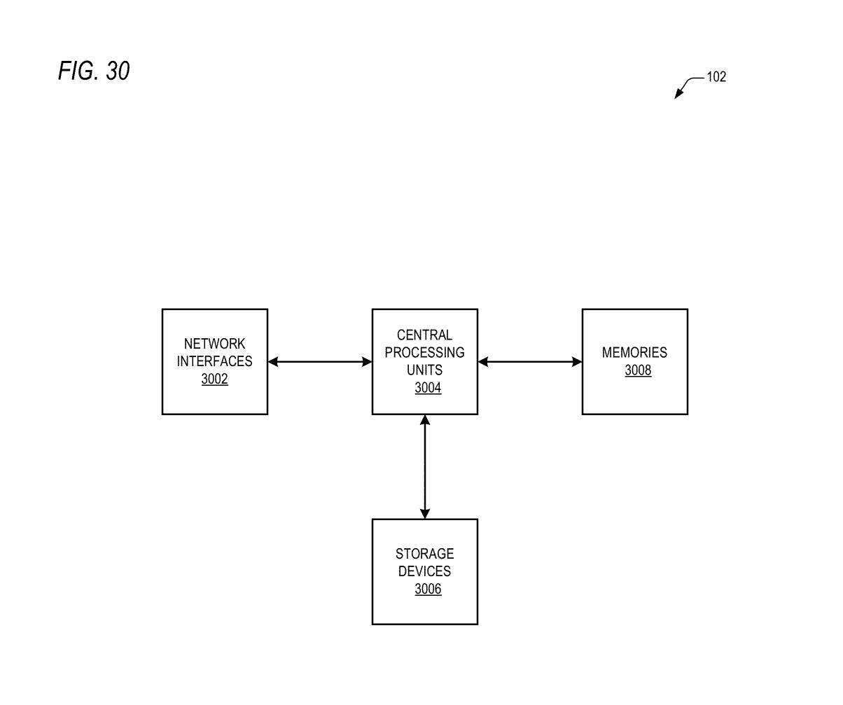

Referring now to FIG. 30, a block diagram illustrating an embodiment of the TTPP system 102 of FIGS. 1 and 21 according to an embodiment of the present invention is shown. The TTPP system 102 includes one or more central processing units (CPUs) 3004 in communication with one or more memories 3008, one or more storage devices 3006, and one or more network interfaces 3002. Specifically, the CPUs 3004 perform many of the operations described herein, particularly with respect to the flowcharts above, including but not limited to, the following operations: to use the payment instrument information to pay the bills to the systems operated by the billers with funds of the bill helpers; to pay partial amounts of the bill with funds of each of the plurality of bill helpers; to determine that a sum of the portions of the item price the plurality of benefactors agreed to pay has reached the item price, as described above with respect to blocks 2225, 2525, 2825 and 2925, for example, and in response pay the merchant for the item, as described above with respect to blocks 2214, 2226, 2514, 2814 and 2914, for example; to create the wish list from the catalog or plurality of catalogs based on input received from an electronic device of the beneficiary, as described above with respect to block 2712; and to create the wish list from the plurality of wish lists received from the computer systems of the plurality of merchants, as described above with respect to block 2606. The storage devices 3006 may be disk drives, tape drives, solid-state disks (SSDs), or other similar mass storage devices for storing programs executed by the CPUs 3004 and for storing data processed by the CPUs 3004. The memories 3008 may be RAM, FLASH, ROM or other similar memories for storing programs executed by the CPUs 3004 and for storing data processed by the CPUs 3004. The network interfaces 3002 interface the CPUs 3004, memories 3008 and storage devices 3006 of the TTPP system 102 to other systems and devices of the network 100. The network interfaces 3002 may comprise various interfaces such as Fibre Channel, Ethernet, InfiniBand, SCSI, HIPPI, Token Ring, Arcnet, FDDI, LocalTalk, ESCON, FICON, ATM, SAS, SATA, iSCSI, and the like. Specifically, the network interfaces 3002 perform many of the operations described herein, particularly with respect to the flowcharts above, including but not limited to, the following operations: to communicate with a device to receive bill information about bills of a bill owner and to communicate with a plurality of devices to receive payment instrument information of each of a plurality of bill helpers; to communicate with systems operated by billers to whom the bills are owed by the bill owner; for each of a plurality of benefactors, to send to an electronic device of the benefactor information specifying an item desired by a beneficiary, as described above with respect to block 2207, for example; for each of the plurality of benefactors, receive from the benefactor electronic device information specifying a portion of the item price the benefactor agrees to pay, as described above with respect to block 2208, for example; to receive contact information of each of the plurality of benefactors from an electronic device of the beneficiary, as described above with respect to block 2202, for example; to receive the wish list from a computer system of the merchant, as described above with respect to blocks 2204 and 2604, for example; to receive a catalog of items offered for sale by the merchant from a computer system of the merchant, as described above with respect to block 2704, for example; to receive a plurality of wish lists from a plurality of computer systems of a plurality of merchants that includes the merchant, as described above with respect to blocks 2204 and 2604, for example; and to receive a plurality of catalogs of items offered for sale by a plurality of merchants that includes the merchant from a plurality of computer systems of the plurality of merchants, as described above with respect to block 2704, for example. As described above, the TTPP system 102 may be a combination of computers in communication via a communications network, such as a local area network, wide area network, and/or telecommunications network.

The following potential advantages may be provided by various embodiments described herein.

The TTPP system 102 provides the ability for the benefactors to know that the money they are paying is going directly to the merchant, rather than the beneficiary, and is not being used for another purpose. This may foster the giving of more help than would otherwise be given.

The TTPP system 102 may increase the likelihood that items are purchased from merchants, which may in turn motivate merchants to absorb some or all of the transaction costs associated with the payments, thereby reducing the cost of helping pay for items. This may foster the giving of more help than would otherwise be given.

The TTPP system 102 makes it easier for a person who needs help paying for items (beneficiary) to be found by people or organizations (benefactors) that want to help the person in need. This may foster the giving of more help than would otherwise be given.

The TTPP system 102, because it does not require the benefactor to obtain the item and merchant information, reduces the time and energy the benefactor must expend in paying for a beneficiary's item. This may foster the giving of more help than would otherwise be given.

The TTPP system 102 may increase the benefactor's confidence that the item price is correct (e.g., not inflated by the beneficiary). This may foster the giving of more help than would otherwise be given.

The TTPP system 102 may reduce the amount of embarrassment or shame involved in asking for help by the beneficiaries. This may foster the giving of more help than would otherwise be given.

The TTPP system 102 may enable to the benefactors to understand the longer term needs of the beneficiary and therefore more effectively plan to help the beneficiary. This may foster the giving of more help than would otherwise be given.

The TTPP system 102 may reduce costs of helping pay for items relative to more traditional methods of helping. For example, the fees charged to use the TTPP system 102 may be less than the fees that must be paid in more traditional systems, such as money wire transfers. This may foster the giving of more help than would otherwise be given.

The TTPP system 102 may enable benefactors to pay for items for beneficiaries who are simply physically unable to pay for their items, e.g., due to a medical condition or being out of the country.

The TTPP system 102 may foster the sharing of payments by multiple benefactors on a given item, particularly since the benefactors have more visibility into the fact that a portion of the item is being paid for by other benefactors. For example, if a benefactor sees that $75 of a $100 item has been paid, the benefactor may be willing to pay the remaining $25. This may foster the giving of more help than would otherwise be given.

Although embodiments have been described in which the trusted third party operating the TTPP system 102 and the merchant operating the merchant systems 108 are distinct entities, embodiments are contemplated in which they are the same entity, i.e., the trusted third party is the merchant. That is, the merchant operates the TTPP system 102. In such embodiments, the operations of the merchant systems 108 may be incorporated into the TTPP system 102. Thus, the merchant-operated TTPP system 102 provides the benefactor devices 106 with the information specifying the item desired by the beneficiary and offered for sale by the merchant at the price, and the merchant-operated TTPP system 102 receives from each of the benefactor devices 106 the portion of the item price the benefactor is willing to pay. In one embodiment, the merchant-operated TTPP system 102 waits until the sum of the portions has reached the item price before effecting a transfer of funds from the respective benefactor accounts to the merchant account. In other embodiments, when each benefactor agrees to pay the specified portion, the merchant-operated TTPP system 102 effects a transfer of funds from the benefactor account to the merchant account according to the specified portion, i.e., before the sum of the portions has reached the item price, in a manner similar to a “lay-away” arrangement. Embodiments are contemplated in which the merchant-operated TTPP system 102 is shared by multiple merchants in a cooperative fashion such that benefactors may contribute to paying for multiple items (in some cases multiple benefactors paying a portion of the price of a single item from among the multiple items) in which the multiple items are offered for sale by different merchants.

Although embodiments have been described in which the TTPP system 102 provides a single user interface that enables benefactors/bill helper to pay for items and/or pay bills of a beneficiary/bill owner, embodiments are contemplated in which the TTPP system 102 only enables benefactors to pay for items for a beneficiary, i.e., does not enable enables bill helpers to pay bills of a bill owner.

Although embodiments have been described in which the merchant system is offering an item for sale at a specified price, other embodiments are contemplated in which the merchant, such as eBay®, is auctioning the item such that the price is determined by the bidders in the auction. In such an embodiment, the TTPP system 102 may employ automatic bidding software which monitors the merchant/auctioneer website and automatically increases the bid on behalf of the beneficiary up to an amount that is the sum of the amounts which the benefactors have agreed to pay for the item.

While various embodiments of the present invention have been described herein, it should be understood that they have been presented by way of example, and not limitation. It will be apparent to persons skilled in the relevant project management arts that various changes in form and detail can be made therein without departing from the scope of the invention. Thus, the present invention should not be limited by any of the exemplary embodiments described herein, but should be defined only in accordance with the following claims and their equivalents. Finally, those skilled in the art should appreciate that they can readily use the disclosed conception and specific embodiments as a basis for designing or modifying other structures for carrying out the same purposes of the present invention without departing from the scope of the invention as defined by the appended claims.

I claim:

1. A computer system, comprising:
one or more network interfaces, configured to:
for each of a plurality of benefactors, send to an electronic device of the benefactor information specifying an item desired by a beneficiary, wherein the item is offered for sale by a merchant at a price; and
for each of the plurality of benefactors, receive from the benefactor electronic device information specifying a portion of the item price the benefactor agrees to pay; and
a central processing unit (CPU), configured to determine that a sum of the portions of the item price the plurality of benefactors agreed to pay has reached the item price and in response pay the merchant for the item.

2. The computer system of claim 1, wherein to pay the merchant for the item, for each of the plurality of benefactors, the computer system effects an electronic transfer of funds of the portion agreed to by the benefactor from a financial account of the benefactor to a financial account of the merchant.

3. The computer system of claim 1,
wherein the computer system is operated by a third party;
wherein the beneficiary, the benefactors, the merchant and the third party are all distinct entities.

4. The computer system of claim 3, wherein the computer system is further configured, for each of the plurality of benefactors, to effect an electronic transfer of funds of the portion agreed to by the benefactor from a financial account of the benefactor to a financial account of the third party, wherein to pay the merchant for the item the computer system pays the merchant for the item from the third party financial account.

5. The computer system of claim 1, wherein the one or more network interfaces are further configured to:
receive contact information of each of the plurality of benefactors from an electronic device of the beneficiary; and
wherein to send the information specifying the desired item, the one or more network interfaces sends the information using the contact information.

6. The computer system of claim 1, wherein to send the information specifying the item, the computer system sends to the benefactor electronic device for display thereon a wish list of items desired by the beneficiary, wherein the wish list includes the information specifying the item offered for sale by the merchant.

7. The computer system of claim 6, wherein the one or more network interfaces are further configured to:
receive the wish list from a computer system of the merchant, prior to sending the wish list, wherein the wish list is previously created by the beneficiary on the merchant computer system.

8. The computer system of claim 6,
wherein the one or more network interfaces are further configured to receive a catalog of items offered for sale by the merchant from a computer system of the merchant, wherein the catalog includes the information specifying the item offered for sale by the merchant;
wherein the CPU is further configured to create the wish list from the catalog based on input received from an electronic device of the beneficiary.

9. The computer system of claim 6,
wherein the one or more network interfaces are further configured to receive a plurality of wish lists from a plurality of computer systems of a plurality of merchants that includes the merchant, wherein the plurality of wish lists are previously created by the beneficiary on the plurality of merchant computer systems;
wherein the CPU is further configured to create the wish list from the plurality of wish lists received from the computer systems of the plurality of merchants.

10. The computer system of claim 6,
wherein the one or more network interfaces are further configured to receive a plurality of catalogs of items offered for sale by a plurality of merchants that includes the merchant from a plurality of computer systems of the plurality of merchants, wherein at least one of the catalogs includes the information specifying the item offered for sale by the merchant;
wherein the CPU is further configured to create the wish list from the plurality of catalogs based on input received from an electronic device of the beneficiary.

11. The computer system of claim 1,
wherein the one or more network interfaces are further configured to:
for each of the plurality of benefactors, send to the electronic device of the benefactor information specifying a second item desired by the beneficiary, wherein the second item is offered for sale by a second merchant at a second price; and
for each of the plurality of benefactors, receive from the benefactor electronic device information specifying a portion of the second item price the benefactor agrees to pay;
wherein the CPU is further configured to:
determine, in response to receiving the information specifying a portion of the second item price the benefactor agrees to pay, that a sum of the portions of the second item price the plurality of benefactors agreed to pay has reached the second item price; and
pay the merchant for the second item, in response to determining that the sum of the portions of the second item price the plurality of benefactors agreed to pay has reached the second item price;
wherein the second merchant is distinct from the first merchant.

12. The computer system of claim 1, further comprising:
wherein the one or more network interfaces are further configured to:
receive bill information about bills of the beneficiary/bill owner; and
receive payment instrument information of each of the plurality of benefactors/bill helpers; and
wherein the CPU is further configured to pay the bills with funds of the benefactors/bill helpers using the payment instrument information.

13. A method, comprising:
for each of a plurality of benefactors, sending to an electronic device of the benefactor, by a computer system, information specifying an item desired by a beneficiary, wherein the item is offered for sale by a merchant at a price;
for each of the plurality of benefactors, receiving from the benefactor electronic device, by the computer system, information specifying a portion of the item price the benefactor agrees to pay;
determining, by the computer system, in response to said receiving, that a sum of the portions of the item price the plurality of benefactors agreed to pay has reached the item price; and
paying the merchant for the item, by the computer system, in response to said determining.

14. The method of claim 13, wherein said paying the merchant for the item comprises:
for each of the plurality of benefactors, effecting, by the computer system, in response to said receiving, an electronic transfer of funds of the portion agreed to by the benefactor from a financial account of the benefactor to a financial account of the merchant.

15. The method of claim 13,
wherein the computer system is operated by a third party;
wherein the beneficiary, the benefactors, the merchant and the third party are all distinct entities.

16. The method of claim 15, further comprising:
for each of the plurality of benefactors, effecting, by the computer system, in response to said receiving, an electronic transfer of funds of the portion agreed to by the benefactor from a financial account of the benefactor to a financial account of the third party; and
wherein said paying the merchant for the item comprises paying the merchant for the item, by the computer system, from the third party financial account.

17. The method of claim 13, further comprising:
receiving contact information of each of the plurality of benefactors, by the computer system, from an electronic device of the beneficiary; and
wherein said sending comprises sending the information specifying the desired item using the contact information.

18. The method of claim 13, wherein said sending the information specifying the item comprises sending, by the computer system, to the benefactor electronic device for display thereon a wish list of items desired by the beneficiary, wherein the wish list includes the information specifying the item offered for sale by the merchant.

19. The method of claim 18, further comprising:
receiving the wish list, by the computer system, from a computer system of the merchant, prior to said sending the wish list, wherein the wish list is previously created by the beneficiary on the merchant computer system.

20. The method of claim 18, further comprising:
receiving a catalog of items offered for sale by the merchant, by the computer system, from a computer system of the merchant, wherein the catalog includes the information specifying the item offered for sale by the merchant;
creating the wish list, by the computer system, from the catalog based on input received from an electronic device of the beneficiary.

21. The method of claim 18, further comprising:
receiving a plurality of wish lists, by the computer system, from a plurality of computer systems of a plurality of merchants that includes the merchant, wherein the plurality of wish lists are previously created by the beneficiary on the plurality of merchant computer systems; and
creating the wish list, by the computer system, from the plurality of wish lists received from the computer systems of the plurality of merchants.

22. The method of claim 18, further comprising:
receiving a plurality of catalogs of items offered for sale by a plurality of merchants that includes the merchant, by the computer system, from a plurality of computer systems of the plurality of merchants, wherein at least one of the catalogs includes the information specifying the item offered for sale by the merchant; and
creating the wish list, by the computer system, from the plurality of catalogs based on input received from an electronic device of the beneficiary.

23. The method of claim 13, further comprising:
for each of the plurality of benefactors, sending to the electronic device of the benefactor, by the computer system, information specifying a second item desired by the beneficiary, wherein the second item is offered for sale by a second merchant at a second price;
for each of the plurality of benefactors, receiving, by the computer system, from the benefactor electronic device information specifying a portion of the second item price the benefactor agrees to pay;
determining, by the computer system, in response to said receiving the information specifying a portion of the second item price the benefactor agrees to pay, that a sum of the portions of the second item price the plurality of benefactors agreed to pay has reached the second item price; and
paying the merchant for the second item, by the computer system, in response to said determining that the sum of the portions of the second item price the plurality of benefactors agreed to pay has reached the second item price;
wherein the second merchant is distinct from the first merchant.

24. The method of claim 13, further comprising:
receiving, by the computer system, bill information about bills of the beneficiary/bill owner;
receiving, by the computer system, payment instrument information of each of the plurality of benefactors/bill helpers; and
paying the bills, by the computer system, with funds of the benefactors/bill helpers using the payment instrument information.

25. A non-transitory computer-readable memory medium comprising program instructions, wherein the program instructions are executable by a processor to implement:
for each of a plurality of benefactors, sending to an electronic device of the benefactor, by a computer system, information specifying an item desired by a beneficiary, wherein the item is offered for sale by a merchant at a price;
for each of the plurality of benefactors, receiving from the benefactor electronic device, by the computer system, information specifying a portion of the item price the benefactor agrees to pay;
determining, by the computer system, in response to said receiving, that a sum of the portions of item price the plurality of benefactors agreed to pay has reached the item price; and
paying the merchant for the item, by the computer system, in response to said determining.

26. An apparatus, comprising:
at least one computer;
software that executes on the computer configured to, for each of a plurality of benefactors, send to an electronic device of the benefactor information specifying an item desired by a beneficiary, wherein the item is offered for sale by a merchant at a price;
software that executes on the computer configured to, for each of the plurality of benefactors, receive from the benefactor electronic device information specifying a portion of the item price the benefactor agrees to pay;
software that executes on the computer configured to determine that a sum of the portions of the item price the plurality of benefactors agreed to pay has reached the item price; and
software that executes on the computer configured to pay the merchant for the item when the sum of the portions of the item price the plurality of benefactors agreed to pay has reached the item price.

27. A method, comprising:
for each of a plurality of benefactors, sending to an electronic device of the benefactor, by a computer system, information specifying an item desired by a beneficiary, wherein the item is offered for sale by a merchant at a price;
for each of the plurality of benefactors, receiving, by the computer system, from the benefactor electronic device information specifying a portion of the item price the benefactor agrees to pay; and
for each of the plurality of benefactors, effecting, by the computer system, in response to said receiving, an electronic transfer of funds of the portion agreed to by the benefactor from a financial account of the benefactor to a financial account of the merchant.

28. A method, comprising:
receiving contact information of a benefactor, by a computer system, from an electronic device of a beneficiary;
sending an electronic communication, by the computer system, based on the contact information to an electronic device of the benefactor indicating the beneficiary's desire for an item offered for sale by a merchant;
receiving from the benefactor electronic device, by the computer system, payment instrument information; and
paying the merchant for the item, by the computer system, using the payment instrument information;
wherein the computer system is operated by a third party;
wherein the beneficiary, the benefactor, the merchant and the third party are all distinct entities.

29. The method of claim 28, wherein said paying the merchant for the item comprises:
causing, by the computer system, an electronic transfer of funds of the benefactor directly to a financial account of the merchant using the payment instrument information.
